(19) United States
(12) Patent Application Publication
(10) Pub. No.: US 2026/0107942 A1
(43) Pub. Date: Apr. 23, 2026

(54) FUNGICIDAL COMBINATIONS AND METHOD OF CONTROLLING FUNGAL DISEASES

(71) Applicants: UPL MAURITIUS LIMITED, Port Louis (MU); UPL EUROPE LTD, Warrington Cheshire (GB)

(72) Inventors: Grégory Lecollinet, Saint Malo (FR); Estelle Moreau, Saint Malo (FR); Robert Burton, Evesham Worcestershire (GB)

(21) Appl. No.: 18/865,863

(22) PCT Filed: May 16, 2023
(86) PCT No.: PCT/GB2023/051283

§ 371 Date: Nov. 14, 2024

(30) Foreign Application Priority Data
May 17, 2022 (EP) 22305726.6

(51) Int. Cl. A01N 43/16; A01N 25/04; A01N 25/30; A01N 59/02; A01N 59/20; A01P 3/00

(52) U.S. Cl. CPC A01N 43/16; A01N 25/04; A01N 25/30; A01N 59/02; A01N 59/20; A01P 3/00

(57) ABSTRACT

The present disclosure relates to fungicidal combinations. The present disclosure relates to fungicidal combinations and compositions comprising laminarin and a contact fungicide for controlling fungal diseases in crops. The present disclosure further relates to a method of controlling phytopathogenic fungal diseases.

### TECHNICAL FIELD

The present disclosure relates to fungicidal combinations. The present disclosure relates to fungicidal combinations comprising laminarin and a contact fungicide for controlling fungal diseases in crops. The present disclosure further relates to a method of controlling phytopathogenic fungal diseases.

### BACKGROUND

About 70% to 80% of crop losses due to microbial diseases are caused by fungi. Fungicides are key weapons in agriculture's arsenal, but they pose environmental risks. Over time, phytopathogenic fungi also develop resistance to fungicides, leading growers on an endless quest for new and improved ways to combat fungal diseases. Fungal diseases are an important yield-limiting factor in cereals with estimated yield losses of 15-20% (worth $100-$200 billion) each year; when they occur to a large extent, losses may reach as high as 50%.

Wheat is one of the most cultivated and the most consumed crops globally. It has become a staple in diet of people across many countries. With the demand for wheat set to increase by at least 50% before 2050, global economies are focusing on increasing crop yield and production. Septoria leaf blotch or Septoria tritici blotch (STB) disease is caused by a hemibiotrophic pathogenic fungus Zymoseptoria tritici (Mycosphaerella graminicola and Septoria tritici). The disease is characterised by a long, symptomless fungal growth period in host cells that is followed by a rapid switch to a necrotrophic growth phase. The necrotrophic phase results in lesions that ultimately destroy plant leaves. STB outbreaks can reduce wheat yield by 30% to 40%, therefore, Z. tritici is a major threat to global food security. The pathogen is of particular concern in humid climates, where up to an estimated 700 million euros worth of wheat yield is lost annually to STB. There are no wheat varieties which are fully resistant to this pathogen, and disease control relies heavily on chemical application. However, there are limitations on fungicide usage-reduction according to policies in Europe. In addition, frequent sexual recombination within the pathogen population leads to polymorphisms and to evolution of virulent strains that can overcome host resistance and fungicide tolerance, thus making disease control very difficult.

Yellow rust of cereals (stripe rust), caused by Puccinia striiformis is a highly damaging disease favored by cool temperate conditions. The wheat-adapted form of P. striiformis (Pgt) occurs commonly in Europe and has been controlled by using varieties with different combinations of resistance genes, along with fungicide treatments in epidemic years. However, over time yellow rust has posed a greater threat to global wheat production. The pathogen has migrated on a continental scale, causing epidemics in countries that were previously free from the disease, and aggressive strains have evolved that are not only virulent on previously resistant host varieties, but also adapted to a wider range of climatic conditions. Hence, wheat crops are now vulnerable to P. striformis in many countries and continents.

Sulphur is one of the oldest pesticides known and is widely used for control of powdery mildews, rusts, leaf blights and fruit rots. Sulphur disrupts metabolic processes of fungal phytopathogens and protects plants from diseases by inhibiting spore germination. It works through the process of sublimation, where solid sulphur particles react with atmospheric hydrogen and form hydrogen sulphide gas, which shrouds the plant leaf. As the gas is toxic to fungal pathogens, it has some effect on disease already on the leaf and offers protection against sporulation for a certain time. Traditionally, some plant diseases have been controlled with applications of elemental sulphur, but this necessitates frequent, high-volume applications of sulphur which acts as an irritant, thus causing plant injury in hot and dry weather conditions. Sulphur applications for disease control were commonplace in wheat crops, with sulphur providing some multisite fungicidal activity on key diseases such as STB. The introduction of more effective contact fungicides left it out in the cold for many years, however, due to restrictions imposed on chlorothalonil and mancozeb, the importance of sulphur in fungal disease control cannot not be less stressed upon.

The Applicant's invention in EP 2695519, which is incorporated herein by reference in its entirety, discloses a composition comprising a pesticidally effective amount of mineral oil and a suspension concentrate comprising particulate sulphur suspended in an aqueous medium comprising at least one wetting agent wherein said particulate sulphur has a particle size diameter distribution of D₉₀ less than 3 microns. The sulphur containing composition has improved performance over previously used powder formulations, with its finer and consistent milling process of the active substance giving more uniform leaf coverage and activity.

Laminarins are a class of low molecular weight storage β-glucans, which are composed of (1-3)-β-d-glucan. They consist of (1-3)-β-d-glucopyranose residues with some 6-O-branching in the main chain, and some β-(1-6)-intrachain links are also present. Laminarin is found in the fronds of Laminaria and Saccharina and to a lesser extent in Ascophyllum, Fucus, and Undaria species.

There is a need in the art to provide for the effective control of phytopathogenic fungi using a fungicide combination that provides excellent control of the disease in plants, specifically cereal crops and provides high yield, maintains nutrition and quality of plants.

### OBJECT OF THE INVENTION

It is an object of the present disclosure to provide a fungicidal combination comprising laminarin and a contact fungicide for controlling fungal diseases in cereal crops.

It is an object of the present disclosure to provide a fungicidal combination comprising laminarin and an inorganic compound for controlling fungal diseases in cereal crops.

It is another object of the present disclosure to provide a fungicidal combination comprising laminarin and sulphur for controlling fungal diseases in cereal crops.

It is an object of the present disclosure to provide a fungicidal composition comprising laminarin and a contact fungicide for controlling fungal diseases in cereal crops.

It is an object of the present disclosure to provide a fungicidal composition comprising laminarin and an inorganic compound for controlling fungal diseases in cereal crops.

It is another object of the present disclosure to provide a fungicidal composition comprising laminarin and sulphur for controlling fungal diseases in cereal crops.

It is one object of the present disclosure to provide a method of effectively controlling fungal diseases in cereal crops using a fungicidal combination or composition comprising laminarin and at least a contact fungicide.

It is one object of the present disclosure to provide a method of effectively controlling fungal diseases in cereal crops using a fungicidal combination or composition comprising laminarin and at least an inorganic compound.

It is one object of the present disclosure to provide a method of effectively controlling fungal diseases in cereal crops using a fungicidal combination or composition comprising laminarin and sulphur.

### SUMMARY

The present disclosure relates to fungicidal combinations and compositions comprising a β-1,3-glucan polysaccharide and at least one contact fungicide for controlling fungal diseases in cereal crops. Accordingly, the present disclosure relates to a fungicidal combination and composition comprising laminarin and at least one contact fungicide for controlling fungal diseases in cereal crops.

In an aspect, the present disclosure relates to a fungicidal combination comprising laminarin and at least one contact fungicide comprising an inorganic compound or salts thereof for controlling fungal diseases in cereal crops.

In another aspect, the present disclosure relates to a fungicidal combination comprising laminarin and sulphur or salts thereof for controlling fungal diseases in cereal crops.

In another aspect, the present disclosure relates to a fungicidal combination comprising laminarin, sulphur or salts thereof and a non-ionic surfactant for controlling fungal diseases in cereal crops.

In another aspect, the present disclosure relates to a fungicidal combination comprising laminarin, copper or salts thereof and a non-ionic surfactant for controlling fungal diseases in cereal crops.

In an aspect, the present disclosure relates to a fungicidal composition comprising a β-1,3-glucan polysaccharide, at least one contact fungicide and an agrochemically acceptable excipient for controlling fungal diseases in cereal crops.

In an aspect, the present disclosure relates to a fungicidal composition comprising laminarin, at least one contact fungicide comprising an inorganic compound or salts thereof and an agrochemically acceptable excipient for controlling fungal diseases in cereal crops.

In another aspect, the present disclosure relates to a fungicidal composition comprising laminarin, sulphur or salts thereof and an agrochemically acceptable excipient for controlling fungal diseases in cereal crops.

In another aspect, the present disclosure relates to a fungicidal composition comprising laminarin, copper or salts thereof and an agrochemically acceptable excipient for controlling fungal diseases in cereal crops.

The present disclosure relates to a method of controlling phytopathogenic fungal diseases in cereal crops comprising applying to a locus a fungicidal combination comprising β-1,3-glucan polysaccharide and a contact fungicide.

In an aspect, the present disclosure relates to a method of controlling phytopathogenic fungal diseases in cereal crops comprising applying to a locus a fungicidal combination comprising laminarin and an inorganic compound or salts thereof.

In an aspect, the present disclosure relates to a method of controlling phytopathogenic fungal diseases in cereal crops comprising applying to a locus a fungicidal combination comprising laminarin and sulphur or salts thereof.

In another aspect, the present disclosure relates to a method of controlling phytopathogenic fungal diseases in cereal crops comprising applying to a locus a fungicidal combination comprising laminarin and copper or salts thereof.

In an aspect, the present disclosure relates to a method of controlling Zymoseptoria spp, Zymoseptoria tritici, Puccinia spp., Puccinia striiformis, Pyricularia spp. and Pyricularia oryzae in cereal crops, comprising applying to a locus a fungicidal combination comprising laminarin and an inorganic compound or salts thereof.

In an aspect, the present disclosure relates to a method of controlling Zymoseptoria spp, Zymoseptoria tritici, Puccinia spp., Puccinia striiformis, Pyricularia spp. and Pyricularia oryzae in cereal crops, comprising applying to a locus a fungicidal combination comprising laminarin and sulphur or salts thereof.

The present disclosure relates to a method of controlling phytopathogenic fungal diseases in cereal crops comprising applying to a locus a fungicidal combination comprising (A) laminarin and sulphur, and (B) a non-ionic surfactant, wherein the application is made as a tank-mix, simultaneously or sequentially in no particular order of preference.

In an aspect, the present disclosure relates to a method of controlling phytopathogenic fungal diseases in wheat crops comprising applying to a locus a fungicidal combination comprising (A) laminarin and sulphur, and (B) a non-ionic surfactant, wherein the application is made as a tank-mix, simultaneously or sequentially in no particular order of preference.

In an aspect, the present disclosure relates to a method of controlling phytopathogenic fungal diseases in rice crops comprising applying to a locus a fungicidal combination comprising (A) laminarin and sulphur, and (B) a non-ionic surfactant, wherein the application is made as a tank-mix, simultaneously or sequentially in no particular order of preference.

The present disclosure relates to a method of controlling phytopathogenic fungal diseases in cereal crops comprising applying to a locus a fungicidal composition comprising (A) laminarin and sulphur, and (B) a non-ionic surfactant for controlling fungal diseases in cereal crops, wherein the application is made as a tank-mix, simultaneously or sequentially in no particular order of preference.

In an aspect, the present disclosure relates to a method of controlling phytopathogenic fungal diseases in wheat crops comprising applying to a locus a fungicidal composition comprising (A) laminarin and sulphur, and (B) a non-ionic surfactant for controlling fungal diseases in wheat crops, wherein the application is made as a tank-mix, simultaneously or sequentially in no particular order of preference.

In an aspect, the present disclosure relates to a method of controlling phytopathogenic fungal diseases in rice crops comprising applying to a locus a fungicidal composition comprising (A) laminarin and sulphur, and (B) a non-ionic surfactant, wherein the application is made as a tank-mix, simultaneously or sequentially in no particular order of preference.

In an aspect, the present disclosure relates to a method of controlling phytopathogenic fungal diseases in cereal crops by applying a fungicidal combination comprising laminarin and an inorganic compound or salts thereof in an amount ranging from 0.1 L/ha to 8.0 L/ha, preferably in an amount ranging from 0.5 L/ha to 5 L/ha.

In an aspect, the present disclosure relates to a method of controlling phytopathogenic fungal diseases in wheat crop by applying a fungicidal combination comprising laminarin and sulphur or salts thereof in an amount ranging from 0.1 L/ha to 8.0 L/ha, preferably in an amount ranging from 0.5 L/ha to 5 L/ha.

In an aspect, the present disclosure relates to a method of controlling phytopathogenic fungal diseases in rice crop by applying a fungicidal combination comprising laminarin and sulphur or salts thereof in an amount ranging from 0.1 L/ha to 8.0 L/ha, preferably in an amount ranging from 0.5 L/ha to 5 L/ha.

In an aspect, the present disclosure relates to use of a fungicidal combination and/or composition comprising laminarin and a contact fungicide comprising an inorganic compound or salts thereof for controlling phytopathogenic fungal diseases in cereal crops.

In an aspect, the present disclosure relates to use of a fungicidal combination and/or composition comprising laminarin and sulphur or its salts for controlling phytopathogenic fungal diseases in cereal crops.

In an aspect, the present disclosure relates to use of a fungicidal combination and/or composition comprising laminarin and copper or its salts for controlling phytopathogenic fungal diseases in cereal crops.

In another aspect, the present disclosure relates to a kit of parts for controlling phytopathogenic fungal diseases in cereal crops comprising;
(i) laminarin,
(ii) at least one contact fungicide comprising an inorganic compound or its salts, and
(iii) a non-ionic surfactant.

### DETAILED DESCRIPTION

For the purposes of the following detailed description, it is to be understood that the invention may assume various alternative variations, except where expressly specified to the contrary. Moreover, other than in any operating examples, or where otherwise indicated, all numbers expressing, for example, quantities of materials/ingredients used in the specification are to be understood as being modified in all instances by the term “about”. The term “about” used to qualify the amounts of active components shall be interpreted to mean “approximately” or “reasonably close to” and any statistically insignificant variations therefrom.

As used herein, the terms “comprising” “including,” “having,” “containing,” “involving,” and the like are to be understood to be open-ended, i.e., to mean including but not limited to.

In any aspect or embodiment described hereinbelow, the phrase comprising may be replaced by the phrases “consisting of” or “consisting essentially of”. In these aspects or embodiment, the combination or composition described includes or comprises or consists of or consists essentially of or consists substantially of the specific components recited therein, to the exclusion of other ingredients or excipients not specifically recited therein.

The term ‘disease control’ as used herein denotes control and prevention of a disease. Controlling effects include all deviation from natural development, for example: killing, retardation, inhibition or decrease of the fugal disease.

The term “plants” refers to all physical parts of a plant, including seeds, seedlings, saplings, roots, tubers, stems, stalks, foliage and fruits.

The term “locus” of a plant as used herein is intended to embrace the place on which the plants are growing, where the plant propagation materials of the plants are sown or where the plant propagation materials of the plants will be placed into the soil.

The term “plant propagation material” is understood to denote generative parts of a plant, such as seeds, vegetative material such as cuttings or tubers, roots, fruits, tubers, bulbs, rhizomes and parts of plants, germinated plants and young plants which are to be transplanted after germination or after emergence from the soil. These young plants may be protected before transplantation by a total or partial treatment by immersion.

The term “pesticidally effective amount” of mineral oil is that quantity of mineral oil which when applied in that ‘amount will provide the required control of insect and pests. The amount is dependent upon many factors including, for example, the crop, pest to be controlled and environmental conditions. The selection of the proper quantity of active agent to be applied, however, is within the expertise of one skilled in the art and is not considered particularly limiting.

The term “fungicidally effective amount” of an active refers to that quantity of the active which when applied provides the required control of insect and pests.

The term “agriculturally acceptable amount of active” refers to an amount of an active that kills or inhibits the plant disease for which control is desired, in an amount not significantly toxic to the plant being treated.

As used herein, the term % disease severity refers to the percentage decay observed in the crops in terms of the percentage of relevant host tissues covered by lesions or damaged by the disease. Severity results from the number and size of the lesions. The % severity indicates the extent of damage caused by the disease.

As used herein, the terms % disease control refers to the % control and prevention of a disease in crops.

The terms “g ai/L” as used herein denotes the concentration of the respective active ingredient in “grams” present “per litre” of the composition.

The terms “g ai/ha” as used herein denotes the concentration of the respective active ingredient in “grams” applied “per hectare” of the crop field.

The term ‘laminarin concentrate’ refers to laminarin in the purified form as a concentrate that has had the majority of its base component removed. The laminarin concentrate herein comprises laminarin and water. Accordingly, the % of laminarin herein is in the range of 1% to 20%, preferably from 1% to 10%.

The term ‘sulphur’ ‘sulfur’ or sulphur compound refer to the active sulphur used in the present invention.

References to the fungal species of Zymoseptoria tritici, also mean references to synonyms of the said species including Septoria tritici, Mycosphaerella graminicola, the said species belonging to filamentous fungus, an ascomycete in the Mycosphaerellaceae family.

Each of the aspects described above may have one or more embodiments.

Each of the embodiments described hereinafter may apply to one or all the aspects described hereinabove. These embodiments are intended to be read as being preferred features of one or all the aspects described hereinabove. Each of the embodiments described hereinafter applies to each of the aspects described hereinabove individually.

It has been unexpectedly found that a fungicidal combination comprising of laminarin and a contact fungicide effectively controlled phytopathogenic fungi in cereal crops. Particularly, it was found that a combination comprising of laminarin and an inorganic compound such as sulphur effectively inhibited Zymoseptoria sp. Puccinia sp. Pyricularia sp., in plant foliage, preferably in cereals, specifically in wheat and rice. Without wishing to be bound by theory, it is believed that the present combination comprising sulphur as the contact fungicide which exhibits good fungicidal efficacy against the target phytopathogen and in combination with laminarin triggers the natural defense mechanisms to put the plant in a defensive state before the fungal onslaught occurs, almost completely inhibiting the development of this pathogen into wheat leaf tissues. The combination effectively prevents Zymoseptoria spp. from infecting the remaining portion of the plant and reducing the susceptibility of the plant towards the infection.

It is understood from the observations of the application of the present combination comprising laminarin and sulphur to achieve a better fungal control effect. It is believed that once laminarin is applied, it activates three different mechanisms of defense: reinforcement of the walls (plants produce lignin to have stronger physical barriers against pathogens), production of phytoalexins that prevent pathogen development, and production of pathogenesis related (PR) proteins that attack pathogen cell walls.

Therefore, the present disclosure provides a fungicide combination and a composition which effectively controls phytopathogenic fungal diseases, specifically fungal leaf spot diseases caused by Zymoseptoria tritici or Puccinia striformis or Pyricularia oryzae fungi in cereal crop plants. The present invention further provides a method for controlling infestation in crops infected with Septoria leaf blotch, and providing excellent control over said disease in plants and provides high cereal yields, maintain nutrition and quality of the plants. The present disclosure also provides a significantly improved alternative for control of phytopathogenic fungi over chemical pesticides. The application of laminarin and the inorganic compound such as sulphur or copper or salts thereof prevents the entry of harmful pesticidal residues in the food chain, thus eventually providing cereals having good nutritional quality.

The present disclosure relates to fungicidal combinations and compositions comprising a β-1,3-glucan polysaccharide and a contact fungicide for controlling phytopathogenic fungal diseases in cereal crops.

In an embodiment, the β-1,3-glucan polysaccharide comprises laminarin.

Accordingly, the present disclosure relates to a fungicidal combination comprising laminarin and at least one contact fungicide for controlling phytopathogenic fungal diseases in cereal crops.

In an embodiment, the contact fungicide(s) is selected from the group comprising an inorganic compound, dithiocarbamates, phthalimides, chloronitriles, sulfamides, bis-guanidines, triazines, quinones, quinoxalines, maleimide and thiocarbamates.

In an embodiment, the present disclosure relates to a fungicidal combination comprising laminarin and an inorganic compound or its salts for controlling phytopathogenic fungal diseases in cereal crops.

In an embodiment, the present disclosure relates to a fungicidal combination comprising laminarin and an inorganic compound or its salts for controlling phytopathogenic fungal diseases in wheat crops.

In an embodiment, the present disclosure relates to a fungicidal combination comprising laminarin and an inorganic compound or its salts for controlling phytopathogenic fungal diseases in rice crops.

In an embodiment, the inorganic compound comprising a copper or its salts.

In an embodiment, the copper comprises a copper salt.

In an embodiment, the copper comprises a copper salt selected from copper sulphate, tribasic copper sulphate, dibasic copper sulphate, copper oxychloride, copper chloride, copper oxide, cupric oxide, copper nitrate, copper perchlorate, copper bromide, copper hydroxide, copper iodide, cupric acetate, or copper sulfate pentahydrate.

In a preferred embodiment, the copper comprises tribasic copper sulphate.

In an embodiment, the copper fcomprises copper sulphate.

In a preferred embodiment, the inorganic compound comprises sulphur or it salts.

In an embodiment, the inorganic compound comprises a sulfide salt.

In an embodiment, the inorganic compound comprises a sulphate salt.

In an embodiment, the inorganic compound is a sulphur in the form of elemental sulphur.

In an embodiment, sulphur is formulated as liquid sulphur.

In an embodiment, sulphur particulate sulphur having a particle size distribution based on diameters of D₉₀ which is <50 microns.

In an embodiment, sulphur is particulate sulphur having a particle size distribution based on diameters of D₉₀ which is <25 microns.

In an embodiment, the sulphur is particulate sulphur having a particle size distribution based on diameters of D₉₀ between about 1 and 3 microns, which by itself exhibits a significantly improved rain wash resistance and reduced phytotoxicity to leaf surfaces. Even more surprisingly, such a suspension concentrate having a particle size distribution based on diameters D₉₀ between about 1 and 3 microns, interchangeably alone or in combination with a second multi-site contact fungicide, exhibits significantly improved efficacy against fungal infestations.

The particle size distribution of the particulate sulphur component of the present invention has a D₉₀ of about 1.2 microns.

In an embodiment, the present disclosure relates to a fungicidal combination comprising laminarin and copper or its salts for controlling phytopathogenic fungal diseases in cereal crops.

In an embodiment, the present disclosure relates to a fungicidal combination comprising laminarin and copper or its salts for controlling phytopathogenic fungal diseases in wheat crops.

In an embodiment, the present disclosure relates to a fungicidal combination comprising laminarin and copper or its salts for controlling phytopathogenic fungal diseases in rice crops.

In an embodiment, the present disclosure relates to a fungicidal combination comprising laminarin and sulphur or its salts for controlling phytopathogenic fungal diseases in cereal crops.

In an embodiment, the present disclosure relates to a fungicidal combination comprising laminarin and sulphur or its salts for controlling phytopathogenic fungal diseases in wheat crops.

In an embodiment, the present disclosure relates to a fungicidal combination comprising laminarin and sulphur or its salts for controlling phytopathogenic fungal diseases in rice crops.

In an embodiment, the present disclosure relates to a fungicidal combination comprising laminarin and an inorganic compound or its salts for controlling Zymoseptoria sp. in wheat crops.

In an embodiment, the present disclosure relates to a fungicidal combination comprising laminarin and an inorganic compound or its salts for controlling Zymoseptoria tritici in wheat crops.

In an embodiment, the present disclosure relates to a fungicidal combination comprising laminarin and an inorganic compound or its salts for controlling Puccinia sp. in wheat crops.

In an embodiment, the present disclosure relates to a fungicidal combination comprising laminarin and an inorganic compound or its salts for controlling Puccinia striiformis in wheat crops.

In an embodiment, the present disclosure relates to a fungicidal combination comprising laminarin and sulphur or its salts for controlling Zymoseptoria sp. in wheat crops.

In an embodiment, the present disclosure relates to a fungicidal combination comprising laminarin and sulphur or its salts for controlling Zymoseptoria tritici in wheat crops.

In an embodiment, the present disclosure relates to a fungicidal combination comprising laminarin and sulphur or its salts for controlling Puccinia sp. in wheat.

In an embodiment, the present disclosure relates to a fungicidal combination comprising laminarin and sulphur or its salts for controlling Puccinia striiformis in wheat.

In an embodiment, the present disclosure relates to a fungicidal combination comprising laminarin and sulphur or its salts for controlling Pyricularia sp. in rice.

In an embodiment, the present disclosure relates to a fungicidal combination comprising laminarin and sulphur or its salts for controlling Pyricularia oryzae in rice.

In an embodiment, the present disclosure relates to a fungicidal combination comprising laminarin and at least one contact fungicide in a ratio ranging from 1:100 to 100:1 for controlling phytopathogenic fungal diseases in cereal crops.

In an embodiment, the present disclosure relates to a fungicidal combination comprising laminarin and at least one contact fungicide in a ratio ranging from 1:80 to 80:1 for controlling phytopathogenic fungal diseases in cereal crops.

In a preferred embodiment, the present disclosure relates to a fungicidal combination comprising laminarin and at least one contact fungicide in a ratio ranging from 1:75 to 75:1 for controlling phytopathogenic fungal diseases in cereal crops.

In a preferred embodiment, the present disclosure relates to a fungicidal combination comprising laminarin and at least one contact fungicide in a ratio ranging from 1:70 to 70:1 for controlling phytopathogenic fungal diseases in cereal crops.

In an embodiment, the present disclosure relates to a fungicidal combination comprising laminarin and at least one inorganic compound or its salts in a ratio ranging from 1:100 to 100:1 for controlling phytopathogenic fungal diseases in cereal crops.

In an embodiment, the present disclosure relates to a fungicidal combination comprising laminarin and at least one inorganic compound or its salts in a ratio ranging from 1:80 to 80:1 for controlling phytopathogenic fungal diseases in cereal crops.

In a preferred embodiment, the present disclosure relates to a fungicidal combination comprising laminarin and at least one inorganic compound or its salts in a ratio ranging from 1:75 to 75:1 for controlling phytopathogenic fungal diseases in cereal crops.

In a preferred embodiment, the present disclosure relates to a fungicidal combination comprising laminarin and at least one inorganic compound or its salts in a ratio ranging from 1:70 to 70:1 for controlling phytopathogenic fungal diseases in cereal crops.

In an embodiment, the present disclosure relates to a fungicidal combination comprising laminarin and sulphur or its salts in a ratio ranging from 1:100 to 100:1 for controlling phytopathogenic fungal diseases in cereal crops.

In an embodiment, the present disclosure relates to a fungicidal combination comprising laminarin and sulphur or its salts in a ratio ranging from 1:80 to 80:1 for controlling phytopathogenic fungal diseases in cereal crops.

In a preferred embodiment, the present disclosure relates to a fungicidal combination comprising laminarin and sulphur or its salts in a ratio ranging from 1:75 to 75:1 for controlling phytopathogenic fungal diseases in cereal crops.

In a preferred embodiment, the present disclosure relates to a fungicidal combination comprising laminarin and sulphur or its salts in a ratio ranging from 1:70 to 70:1 for controlling phytopathogenic fungal diseases in cereal crops.

In an embodiment, the present disclosure relates to a fungicidal combination comprising laminarin and sulphur or its salts in a ratio ranging from 1:100 to 100:1 for controlling Zymoseptoria sp. in wheat crop.

In an embodiment, the present disclosure relates to a fungicidal combination comprising laminarin and sulphur or its salts in a ratio ranging from 1:80 to 80:1 for controlling Zymoseptoria sp. in wheat crop.

In a preferred embodiment, the present disclosure relates to a fungicidal combination comprising laminarin and sulphur or its salts in a ratio ranging from 1:75 to 75:1 for controlling Zymoseptoria sp. in wheat crop.

In a preferred embodiment, the present disclosure relates to a fungicidal combination comprising laminarin and sulphur or its salts in a ratio ranging from 1:70 to 70:1 for controlling Zymoseptoria sp. in wheat crop.

In an embodiment, the present disclosure relates to a fungicidal combination comprising laminarin and sulphur or its salts in a ratio ranging from 1:100 to 100:1 for controlling Zymoseptoria tritici in wheat crop.

In an embodiment, the present disclosure relates to a fungicidal combination comprising laminarin and sulphur or its salts in a ratio ranging from 1:80 to 80:1 for controlling Zymoseptoria tritici in wheat crop.

In a preferred embodiment, the present disclosure relates to a fungicidal combination comprising laminarin and sulphur or its salts in a ratio ranging from 1:75 to 75:1 for controlling Zymoseptoria tritici in wheat crop.

In a preferred embodiment, the present disclosure relates to a fungicidal combination comprising laminarin and sulphur or its salts in a ratio ranging from 1:70 to 70:1 for controlling Zymoseptoria tritici in wheat crop.

In an embodiment, the present disclosure relates to a fungicidal combination comprising laminarin and sulphur or its salts in a ratio ranging from 1:100 to 100:1 for controlling Puccinia sp. in wheat crop.

In an embodiment, the present disclosure relates to a fungicidal combination comprising laminarin and sulphur or its salts in a ratio ranging from 1:80 to 80:1 for controlling Puccinia sp in wheat crop.

In a preferred embodiment, the present disclosure relates to a fungicidal combination comprising laminarin and sulphur or its salts in a ratio ranging from 1:75 to 75:1 for controlling Puccinia sp in wheat crop.

In a preferred embodiment, the present disclosure relates to a fungicidal combination comprising laminarin and sulphur or its salts in a ratio ranging from 1:70 to 70:1 for controlling Puccinia sp in wheat crop.

In an embodiment, the present disclosure relates to a fungicidal combination comprising laminarin and sulphur or its salts in a ratio ranging from 1:100 to 100:1 for controlling Puccinia striiformis in wheat crop.

In an embodiment, the present disclosure relates to a fungicidal combination comprising laminarin and sulphur or its salts in a ratio ranging from 1:80 to 80:1 for controlling Puccinia striiformis in wheat crop.

In a preferred embodiment, the present disclosure relates to a fungicidal combination comprising laminarin and sulphur or its salts in a ratio ranging from 1:75 to 75:1 for controlling Puccinia striiformis in wheat crop.

In a preferred embodiment, the present disclosure relates to a fungicidal combination comprising laminarin and sulphur or its salts in a ratio ranging from 1:70 to 70:1 for controlling Puccinia striiformis in wheat crop.

In an embodiment, the present disclosure relates to a fungicidal combination comprising laminarin and sulphur or its salts in a ratio ranging from 1:100 to 100:1 for controlling fungal diseases in rice crop.

In an embodiment, the present disclosure relates to a fungicidal combination comprising laminarin and sulphur or its salts in a ratio ranging from 1:80 to 80:1 for controlling fungal diseases in rice crop.

In a preferred embodiment, the present disclosure relates to a fungicidal combination comprising laminarin and sulphur or its salts in a ratio ranging from 1:75 to 75:1 for controlling fungal diseases in rice crop.

In a preferred embodiment, the present disclosure relates to a fungicidal combination comprising laminarin and sulphur or its salts in a ratio ranging from 1:70 to 70:1 for controlling fungal diseases in rice crop.

In an embodiment, the present disclosure relates to a fungicidal combination comprising laminarin and sulphur or its salts in a ratio ranging from 1:100 to 100:1 for controlling Pyricularia sp. in rice crop.

In an embodiment, the present disclosure relates to a fungicidal combination comprising laminarin and sulphur or its salts in a ratio ranging from 1:80 to 80:1 for controlling laminarin and sulphur or its salts in a ratio ranging from 1:100 to 100:1 for controlling Pyricularia sp. in rice crop.

In a preferred embodiment, the present disclosure relates to a fungicidal combination comprising laminarin and sulphur or its salts in a ratio ranging from 1:75 to 75:1 for controlling laminarin and sulphur or its salts in a ratio ranging from 1:100 to 100:1 for controlling Pyricularia sp. in rice crop.

In a preferred embodiment, the present disclosure relates to a fungicidal combination comprising laminarin and sulphur or its salts in a ratio ranging from 1:70 to 70:1 for controlling laminarin and sulphur or its salts in a ratio ranging from 1:100 to 100:1 for controlling Pyricularia sp. in rice crop.

In an embodiment, the present disclosure relates to a fungicidal combination comprising laminarin and an inorganic compound for controlling fungal diseases, wherein the weight ratio of laminarin and an inorganic compound is ranging from 1:100 to 100:1, 1:80 to 80:1, 1:70 to 70:1, 1:50 to 50:1, 1:20 to 20:1, 1:10 to 10:1, 1:5 to 5:1 and 1:2 to 2:1.

In an embodiment, the present disclosure relates to a fungicidal combination comprising laminarin and a sulphur for controlling fungal diseases, wherein the weight ratio of laminarin and sulphur is ranging from 1:100 to 100:1, 1:80 to 80:1, 1:70 to 70:1, 1:50 to 50:1, 1:20 to 20:1, 1:10 to 10:1, 1:5 to 5:1 and 1:2 to 2:1.

In an embodiment, laminarin is formulated as water dispersible granules (WDG), dusts, soluble (liquid) concentrates, suspension concentrates (SC), oil in water emulsion, water in oil emulsion, emulsifiable concentrates, capsule suspensions, ZC formulations, oil dispersions or other known formulation types.

In a preferred embodiment, laminarin is formulated as a soluble liquid (SL) concentrate formulation.

In an embodiment, laminarin in the SL formulation is in a concentration ranging from 1 to 100 g/L.

In an embodiment, laminarin in the SL formulation is in a concentration ranging from 1 to 50 g/L.

In a preferred embodiment, laminarin in the SL formulation is in a concentration ranging from 5 to 45 g/L.

In a preferred embodiment, laminarin in the SL formulation is in a concentration ranging from 10 to 40 g/L.

In a preferred embodiment, laminarin in the SL formulation is in a concentration ranging from 10 to 50 g/L.

In a preferred embodiment, laminarin in the SL formulation is in a concentration ranging from 25 to 50 g/L.

In a preferred embodiment, laminarin in the SL formulation is in a concentration of 37 g/L.

In an embodiment, laminarin in the SL formulation is in a concentration ranging from 0.1% to 10% w/w.

In an embodiment, laminarin in the SL formulation is in a concentration ranging from 0.1% to 5% w/w.

In an embodiment, laminarin in the SL formulation is in a concentration ranging from 0.5% to 4.5% w/w.

In a preferred embodiment, laminarin in the SL formulation is in a concentration ranging from 0.1% to 4% w/w of the composition.

In a preferred embodiment, laminarin in the SL formulation is in a concentration ranging from 0.1% to 5% w/w of the composition.

In a preferred embodiment, laminarin in the SL formulation is in a concentration ranging from 2.5% to 5.0% w/w of the composition.

In a preferred embodiment, laminarin in the SL formulation is in a concentration of 3.7% w/w of the composition.

In a preferred embodiment, laminarin in the SL formulation is in a concentration of 3% w/w of the composition.

In a preferred embodiment, sulphur is formulated as a liquid formulation.

In an embodiment, sulphur in the liquid formulation is in a concentration ranging from 100 to 2000 g/L of the composition.

In an embodiment, sulphur in the liquid formulation is in a concentration ranging from 200 to 1000 g/L of the composition.

In a preferred embodiment, sulphur in the liquid formulation is in a concentration ranging from 400 to 1000 g/L of the composition.

In a preferred embodiment, sulphur in the liquid formulation is in a concentration ranging from 400 to 800 g/L of the composition.

In a preferred embodiment, sulphur in the liquid formulation is in a concentration ranging from 500 to 750 g/L of the composition.

In an embodiment, sulphur in the liquid formulation is in a concentration ranging from 20% to 99% w/w of the composition.

In an embodiment, sulphur in the liquid formulation is in a concentration ranging from 40% to 99% w/w of the composition.

In a preferred embodiment, sulphur in the liquid formulation is in a concentration ranging from 40% to 80% w/w of the composition.

In a preferred embodiment, sulphur in the liquid formulation is in a concentration ranging from 50% to 75% w/w of the composition.

In an embodiment, the constituents of the present combination for use in the method of the present disclosure may be tank mixed and sprayed at the locus of the infection or may be optionally mixed with surfactants and then sprayed.

In an embodiment, the fungicidal combination comprising A) laminarin, sulphur and B) the non-ionic surfactant is applied as a tank mix or simultaneously or sequentially in no particular order of preference.

In a preferred embodiment, the fungicidal combination comprising A) laminarin, sulphur and B) the non-ionic surfactant is applied as a tank mix.

In an embodiment, the present disclosure relates to a fungicidal combination for controlling phytopathogenic fungal diseases in cereal crops, the combination comprising;
(i) laminarin,
(ii) a contact fungicide, and
(iii) at least one non-ionic surfactant.

Accordingly, in an embodiment, the present disclosure relates to a fungicidal combination for controlling phytopathogenic fungal diseases in cereal crops, the combination comprising;
(i) laminarin,
(ii) an inorganic compound or its salts, and
(iii) at least one non-ionic surfactant.

In an embodiment, the non-ionic surfactant is hydrophilic.

In an embodiment, the non-ionic surfactant comprises fatty acids, ethoxylated fatty acids, fatty alcohols, ethoxylated fatty alcohols, polyethers and ethoxylated castor oil.

In an embodiment, the non-ionic surfactant comprises polyethers.

In an embodiment, the polyether comprises polyoxyethylene cetyl ethers, polyoxyethylene oleyl ethers, polyoxyethylene stearyl ethers, polyoxyethylene lauryl ethers, polyoxyethylene isocetyl ethers, polyoxyethylene isostearyl ethers, polyoxyethylene octydodecyl ethers, polyoxyethylene behenyl ethers, polyoxyethylene decyltetradecyl ethers, polyoxyethylene chloesteryl ethers, polyoxyethylene polyoxypropylene ethers.

The non-ionic surfactant includes ester type products including fatty acid esters, sorbitan fatty acid esters, fatty acid monoglycerides, fatty acid triglycerides, propylene glycol fatty acid esters, ethylene glycol fatty acid esters, and the like.

In an embodiment the ether-ester non-ionic materials include polyethyleneglycol monostearates, polyethyleneglycol monooleates, polyethyleneglycol monolaurate, polyoxyethylene hydrogenated castor oils, polyoxyethylene glyceryl monostearates, polyethyleneglycol monoisostearates, polyoxyethylene castor oils, polyoxyethylene cetyl ether stearates, polyoxyethylene stearyl ether stearates, polyoxyethylene lauryl ether stearates, polyoxyethylene lauryl ether isostearates, polyethyleneglycol dilaurates, polyethyleneglycol distearates, polyethyleneglycol diisostearates, polyethyleneglycol dioleates, polyethylene sorbitan fatty acid esters, and polyethylene sorbitan fatty acid esters, and the like.

In an embodiment, the polyether comprises polyoxyethylene lauryl ether.

In an embodiment, the ethoxylated fatty alcohol comprises polyethylene glycol stearates.

In a preferred embodiment, the present disclosure relates to a fungicidal combination for controlling phytopathogenic fungal diseases in cereal crops, the combination comprising;
(i) laminarin,
(ii) an inorganic compound or its salts, and
(iii) one or more polyethers.

In a more preferred embodiment, the present disclosure relates to a fungicidal combination for controlling phytopathogenic fungal diseases in cereal crops, the combination comprising;
(i) laminarin,
(ii) sulphur or its salts, and
(iii) one or more polyethers.

In a preferred embodiment, the present disclosure relates to a fungicidal combination for controlling phytopathogenic fungal diseases in wheat crop, the combination comprising;
(i) laminarin,
(ii) sulphur or its salts, and
(iii) one or more polyethers.

In a preferred embodiment, the present disclosure relates to a fungicidal combination for controlling phytopathogenic fungal diseases in rice crop, the combination comprising;
(i) laminarin,
(ii) sulphur or its salts, and
(iii) one or more polyethers.

In a more preferred embodiment, the present disclosure relates to a fungicidal combination for controlling phytopathogenic fungal diseases in cereal crops, the combination comprising;
(i) laminarin,
(ii) sulphur or its salts, and
(iii) polyoxyethylene lauryl ether.

In a more preferred embodiment, the present disclosure relates to a fungicidal combination for controlling phytopathogenic fungal diseases in wheat crop, the combination comprising;
(i) laminarin,
(ii) sulphur or its salts, and
(iii) polyoxyethylene lauryl ether.

In a more preferred embodiment, the present disclosure relates to a fungicidal combination for controlling phytopathogenic fungal diseases in rice crop, the combination comprising;
(i) laminarin,
(ii) sulphur or its salts, and
(iii) polyoxyethylene lauryl ether.

In an embodiment, the non-ionic surfactant is in a concentration ranging from 1 to 70 g/L.

In an embodiment, the non-ionic surfactant is in a concentration ranging from 5 to 60 g/L.

In an embodiment, the non-ionic surfactant is in a concentration ranging from 10 to 45 g/L.

In an embodiment, the non-ionic surfactant is in a concentration of 20 g/L.

In an embodiment, the non-ionic surfactant is in a concentration of 15 g/L.

In an embodiment, the non-ionic surfactant is in a concentration of 10 g/L.

In an embodiment, the polyether is in a concentration ranging from 1 to 70 g/L.

In an embodiment, the polyether is in a concentration ranging from 5 to 60 g/L.

In an embodiment, the polyether is in a concentration ranging from 10 to 45 g/L.

In an embodiment, the polyether is in a concentration of 20 g/L.

In an embodiment, the polyether is in a concentration of 15 g/L.

In an embodiment, the polyether is in a concentration of 10 g/L.

In an embodiment, polyoxyethylene lauryl ether is in a concentration ranging from 1 to 70 g/L.

In an embodiment, polyoxyethylene lauryl ether is in a concentration ranging from 5 to 60 g/L.

In an embodiment, polyoxyethylene lauryl ether is in a concentration ranging from 10 to 45 g/L.

In an embodiment, polyoxyethylene lauryl ether is in a concentration of 20 g/L.

In an embodiment, polyoxyethylene lauryl ether is in a concentration of 15 g/L.

In an embodiment, polyoxyethylene lauryl ether is in a concentration of 10 g/L.

In an embodiment, the constituents of the combination for use in the methods of the present disclosure may be used for foliar application, ground or applications to plant propagation materials.

In an embodiment, the fungicidal combination comprising laminarin and sulphur is applied as a tank mix.

In an embodiment, the combination comprising laminarin and sulphur is applied in immediate succession.

In an embodiment, the combination comprising laminarin and sulphur is applied as a premix.

In an embodiment, the combination comprising laminarin, sulphur and the non-ionic surfactant is applied in immediate succession.

In an embodiment, the combination comprising laminarin, sulphur and the non-ionic surfactant is applied as a premix.

In an embodiment, the combination comprising laminarin, sulphur and the non-ionic surfactant comprising ethoxylated fatty alcohol is applied as a premix.

In an embodiment, the combination comprising laminarin, sulphur and the non-ionic surfactant comprising a polyether is applied as a premix.

In an embodiment, the combination comprising laminarin, sulphur and polyethylene glycol stearate is applied as a premix.

In an embodiment, the combination further comprises at least an agrochemical selected from herbicides, insecticides, acaricides, fertilizers, nutrients and such other crop growth promoting agents.

In an embodiment, the combination further comprises at least an agrochemical comprising a fungicide.

In a preferred embodiment, the fungicide may be a systemic or contact fungicide.

In an embodiment, the optional third fungicide may be selected from morpholine fungicides, triazole fungicides, acylamino acid fungicides, anilide fungicides, antibiotic fungicides, strobilurin fungicides, aromatic fungicides, arsenical fungicides, aryl phenyl ketone fungicides, benzimidazole fungicides, benzimidazole precursor fungicides, benzothiazole fungicides, bridged diphenyl fungicides, carbamate fungicides, conazole fungicides, copper fungicides, dicarboximide fungicides, dinitrophenol fungicides, dithiocarbamate fungicides, dithiolane fungicides, hydrazide fungicides, imidazole fungicides, inorganic fungicides, organophosphorus fungicides, organotin fungicides, oxathiin fungicides, oxazole fungicides, pyrimidine fungicides, pyrrole fungicides, quinoline fungicides, quinone fungicides, quinoxaline fungicides, thiadiazole fungicides, thiazole fungicides, thiazolidine fungicides, thiocarbamate fungicides, thiophene fungicides, triazine fungicides, triazolopyrimidine fungicides, urea fungicides, zinc fungicides, unclassified fungicides and mixtures thereof.

In an embodiment, the present disclosure provides preferred combinations, compositions and methods thereof. The embodiments described herein describe the preferred embodiments of all these possible combinations, compositions and methods of the invention.

The present disclosure relates to compositions comprising a β-1,3-glucan polysaccharide, at least one contact fungicide and at least one agrochemically acceptable excipient for controlling phytopathogenic fungal diseases in cereal crops.

In an embodiment, the present disclosure provides a fungicidal composition comprising laminarin, at least one contact fungicide and at least one agrochemically acceptable excipient for controlling phytopathogenic fungal diseases in cereal crops.

In an embodiment, the present disclosure provides a fungicidal composition comprising laminarin, at least one contact fungicide and at least one agrochemically acceptable excipient for controlling phytopathogenic fungal diseases in wheat crops.

In an embodiment, the present disclosure provides a fungicidal composition comprising laminarin, at least one contact fungicide and at least one agrochemically acceptable excipient for controlling phytopathogenic fungal diseases in rice crops.

In an embodiment, the contact fungicide(s) is selected from the group comprising an inorganic compound, dithiocarbamates, phthalimides, chloronitriles, sulfamides, bis-guanidines, triazines, quinones, quinoxalines, maleimide and thiocarbamates.

In an embodiment, the inorganic compound comprising copper or its salts.

In an embodiment, copper comprises a copper salt selected from copper sulphate, tribasic copper sulphate, dibasic copper sulphate, copper oxychloride, copper chloride, copper oxide, cupric oxide, copper nitrate, copper perchlorate, copper bromide, copper hydroxide, copper iodide, cupric acetate, or copper sulfate pentahydrate.

In a preferred embodiment, copper comprises tribasic copper sulphate.

In an embodiment, copper comprises copper sulphate.

In a preferred embodiment, the inorganic compound comprises sulphur or it salts.

In an embodiment, the inorganic compound comprises a sulfide salt.

In an embodiment, the inorganic compound comprises a sulphate salt.

In an embodiment, the inorganic compound is sulphur in the form of elemental sulphur.

In a preferred embodiment, the present disclosure relates to a fungicidal composition comprising laminarin, sulphur or its salts and at least one agrochemically acceptable excipient for controlling phytopathogenic fungal diseases in cereal crops.

In a preferred embodiment, the present disclosure relates to a fungicidal composition comprising laminarin, sulphur or its salts and at least one agrochemically acceptable excipient for controlling phytopathogenic fungal diseases in wheat crop.

In a preferred embodiment, the present disclosure relates to a fungicidal composition comprising laminarin, sulphur or its salts and at least one agrochemically acceptable excipient for controlling phytopathogenic fungal diseases in rice crop.

In a preferred embodiment the fungicide composition of the present disclosure comprises each active of laminarin and sulphur in an amount ranging from 10 g/L to 800 g/L.

In an embodiment, the composition according to the invention may contain from 1 to 80% by weight of active compounds, preferably from 5 to 80% by weight.

In an embodiment the composition comprises an effective amount of active ingredient of laminarin is 1% to 80% by weight, in particular 1% to 60% by weight, 1% to 40%, 1% to 30% by weight of the total weight of the composition.

In an embodiment the effective amount of active ingredient of sulphur is preferably 1% to 80% by weight, in particular 2% to 60% by weight, more preferably 5% to 40%, most preferably 10% to 30% by weight of the total weight of the composition.

In an embodiment, the present disclosure provides a fungicide composition comprising laminarin, sulphur and an agrochemically acceptable excipient.

In a preferred embodiment, laminarin is formulated as a suspension concentrate formulation, wherein laminarin is present as a laminarin concentrate in the said formulation.

In an embodiment, the laminarin concentrate is in a concentration ranging from 0.1% w/w to 30% w/w of the composition.

In an embodiment, the laminarin concentrate is in a concentration ranging from 1% w/w to 25% w/w of the composition.

In a preferred embodiment, the laminarin concentrate is in a concentration ranging from 1% w/w to 20% w/w of the composition.

In a preferred embodiment, the laminarin concentrate is in a concentration ranging from 1% w/w to 15% w/w of the composition.

In a preferred embodiment, the laminarin concentrate is in a concentration of 15% w/w of the composition.

In a preferred embodiment, the laminarin concentrate is in a concentration of 10% w/w of the composition.

In an embodiment, laminarin in the laminarin concentrate is in a concentration ranging from 0.1 g/L to 20 g/L of the composition.

In a preferred embodiment, laminarin in the laminarin concentrate is in a concentration ranging from 1 g/L to 15 g/L of the composition.

In a preferred embodiment, laminarin in the laminarin concentrate is in a concentration of 15 g/L of the composition.

In a preferred embodiment, laminarin in the laminarin concentrate is in a concentration of 10 g/L of the composition.

In an embodiment, laminarin in the laminarin concentrate is in a concentration of ranging from 1% w/w to 15% w/w of the composition.

In an embodiment, laminarin in the laminarin concentrate is in a concentration of 10% w/w of the composition.

In an embodiment, laminarin in the laminarin concentrate is in a concentration of 7% w/w of the composition.

In an embodiment, laminarin in the laminarin concentrate is in a concentration of 7.5% w/w of the composition.

In an embodiment, sulphur is in a concentration ranging from 100 to 2000 g/L of the composition.

In an embodiment, sulphur is in a concentration ranging from 200 to 1000 g/L of the composition.

In an embodiment, sulphur is in a concentration ranging from 400 to 1000 g/L of the composition.

In a preferred embodiment, sulphur is in a concentration ranging from 400 to 800 g/L of the composition.

In a preferred embodiment, sulphur is in a concentration ranging from 500 to 750 g/L of the composition.

In a preferred embodiment, sulphur is in a concentration of 733 g/L of the composition.

In an embodiment, sulphur is in a concentration ranging from 0.1% to 80% w/w of the composition.

In an embodiment, sulphur is in a concentration ranging from 1% to 70% w/w of the composition.

In an embodiment, sulphur is in a concentration ranging from 1% to 60% w/w of the composition.

In an embodiment, sulphur is in a concentration ranging from 10% to 55% w/w of the composition.

In an embodiment, sulphur is in a concentration ranging from 45% to 55% w/w of the composition.

In an embodiment, the compositions for use in the methods of the present disclosure may typically be produced by mixing the actives in the composition with an inert carrier, and adding surfactants and other adjuvants and carriers as needed and formulated into solid, or liquid formulations, including but not limited to wettable powders, water dispersible granules (WDG), dusts, soluble (liquid) concentrates, suspension concentrates (SC), oil in water emulsion, water in oil emulsion, emulsifiable concentrates, capsule suspensions, ZC formulations, oil dispersions or other known formulation types. The composition may also be used for treatment of a plant propagation material such as seeds etc.

In an embodiment, the composition of the present disclosure is formulated as a liquid formulation.

In a preferred embodiment, the composition of the present disclosure is formulated as a suspension concentrate (SC).

In an embodiment, the present disclosure relates to a suspension concentrate composition comprising laminarin, at least one contact fungicide comprising an inorganic compound and at least one agrochemically acceptable excipient for controlling phytopathogenic fungal diseases in cereal crops.

In a preferred embodiment, the present disclosure relates to a suspension concentrate composition comprising laminarin, sulphur or its salts and at least one agrochemically acceptable excipient for controlling phytopathogenic fungal diseases in cereal crops.

In a preferred embodiment, the present disclosure relates to a suspension concentrate composition comprising laminarin, copper or its salts and at least one agrochemically acceptable excipient for controlling phytopathogenic fungal diseases in cereal crops.

In an embodiment, the present disclosure relates to a suspension concentrate composition comprising laminarin, at least one contact fungicide comprising an inorganic compound and at least one agrochemically acceptable excipient for controlling phytopathogenic fungal diseases in wheat crops.

In a preferred embodiment, the present disclosure relates to a suspension concentrate composition comprising laminarin, sulphur or its salts and at least one agrochemically acceptable excipient for controlling phytopathogenic fungal diseases in wheat crops.

In a preferred embodiment, the present disclosure relates to a suspension concentrate composition comprising laminarin, copper or its salts and at least one agrochemically acceptable excipient for controlling phytopathogenic fungal diseases in wheat crops.

In an embodiment, the present disclosure relates to a suspension concentrate composition comprising laminarin, at least one contact fungicide comprising an inorganic compound and at least one agrochemically acceptable excipient for controlling phytopathogenic fungal diseases in rice crops.

In a preferred embodiment, the present disclosure relates to a suspension concentrate composition comprising laminarin, sulphur or its salts and at least one agrochemically acceptable excipient for controlling phytopathogenic fungal diseases in rice crops.

In a preferred embodiment, the present disclosure relates to a suspension concentrate composition comprising laminarin, copper or its salts and at least one agrochemically acceptable excipient for controlling phytopathogenic fungal diseases in rice crops.

In an embodiment, the present disclosure relates to a suspension concentrate composition for controlling phytopathogenic fungal diseases in cereal crops, the said composition comprising;
(i) laminarin in a concentration ranging from 1% to 20% w/w of the composition,
(ii) sulphur in a concentration ranging from 10% to 55% w/w of the composition, and
(iii) at least one agrochemically acceptable excipient.

In an embodiment, the present disclosure relates to a suspension concentrate composition for controlling phytopathogenic fungal diseases in cereal crops, the said composition comprising;
(i) laminarin in a concentration ranging from 1% to 15% w/w of the composition,
(ii) sulphur in a concentration ranging from 40% to 55% w/w of the composition, and
(iii) at least one agrochemically acceptable excipient.

In an embodiment, the present disclosure relates to a suspension concentrate composition for controlling phytopathogenic fungal diseases in cereal crops, the said composition comprising;
(i) laminarin in a laminarin concentrate is in a concentration ranging from 1% to 20% w/w of the composition,
(ii) sulphur in a concentration ranging from 10% to 55% w/w of the composition, and
(iii) at least one agrochemically acceptable excipient.

In an embodiment, the present disclosure relates to a suspension concentrate composition for controlling phytopathogenic fungal diseases in cereal crops, the said composition comprising;
(i) laminarin in a laminarin concentrate is in a concentration ranging from 1% to 15% w/w of the composition,
(ii) sulphur in a concentration ranging from 40% to 55% w/w of the composition, and
(iii) at least one agrochemically acceptable excipient.

In an embodiment, the agrochemically acceptable excipient is in a concentration ranging from 0.1% to 50% w/w of the composition.

In an embodiment, the agriculturally acceptable excipient comprises an anti-freeze agent, dispersant, defoamer, preservatives, thickener and solvent.

In an embodiment, the anti-freeze agent comprises glycerine glycols, glycerols, urea and mixtures thereof. In an embodiment, the anti-freeze compound is a glycol selected from the list of ethylene glycol, diethylene glycol, triethylene glycol, propylene glycol, dipropylene glycol, tripropyleneglycol, glycerol, and mixtures thereof. In a preferred embodiment, the anti-freeze agent is glycerine.

In an embodiment, the preservative comprises formaldehyde, alkyl esters of p-hydroxybenzoic acid, sodium benzoate, citric acid, potassium sorbate, 2-bromo-2-nitropropane-1,3-diol, o-phenylphenol, thiazolinones, such as benzisothiazolinone, 5-chloro-2-methyl-4-isothiazolinone, pentachlorophenol, 2,4-dichlorobenzyl alcohol and mixtures thereof.

In an embodiment, the dispersant comprises alkylnaphthalene sulfonate, sodium lignin sulfonate, calcium lignosulfonate.

In an embodiment, the defoamer comprises silicas, polydimethylsiloxane, 2-octanol, Oleic acid, paraffinic waxes, amide waxes, sulfonated oils, organic phosphates, silicone oils, mineral oils, and dimethylpolysiloxane.

In an embodiment, the thickener comprises methylcellulose, carboxymethylcellulose, hydroxypropylcellulose, xanthan gum, synthetic polymers such as acrylic acid polymers, polyvinyl alcohol or polyvinyl pyrrolones, silicic acid or phyllosilicates such as montmorillonite and bentonites, which may be hydrophobized. In a preferred embodiment, the thickener is xanthan gum.

In an embodiment, the solvent comprises water.

In an embodiment, the present invention provides a process for the preparation of the suspension concentrate comprising laminarin and sulphur, the said process comprising;
(i) adding laminarin concentrate with water and agriculturally acceptable excipients including defoamer and preservatives,
(ii) slowly adding the dispersant ensuring rapid wetting to prevent clumping followed by addition of sulphur,
(iii) subjecting the mixture of step (ii) to high shear agitation to ensure homogeneity and sample was then milled to d (0.5)<1 um,
(iv) adding thickener mixture to the millbase under low shear to finally obtain the desired formulation.

The compositions according to the invention may also comprise customary adjuvants, such as viscosity-modifying additives (thickeners), antifoam agents, preservatives, buffers, inorganic dispersants, etc, which are usually employed in aqueous formulations of agrochemicals. Such adjuvants may be incorporated into the formulations of the invention either before or after step (i) of the preparation process described herein has been carried out. They may also be incorporated after step (iii) of the preparation process described herein has been carried out. Preferably these adjuvants are added after completion of step (ii) and before step (iii) of the preparation process. The amount of additives will generally not exceed 0.1% to 50% w/w of the composition.

In an embodiment, the anti-freeze agent is in a concentration ranging from 0.1% to 15% w/w.

In an embodiment, the dispersant is in a concentration ranging from 0.1% to 15% w/w.

In an embodiment, the defoamer is in a concentration ranging from 0.01% to 5% w/w.

In an embodiment, the preservative is in a concentration ranging from 0.01% to 5% w/w.

In an embodiment, the thickener is in a concentration ranging from 0.01% to 2% w/w.

In an embodiment, the solvent is in a concentration ranging from 0.01% to 40% w/w.

Depending on the formulation type, they comprise one or more liquid or solid carriers, if appropriate surfactants (such as dispersants, protective colloids, emulsifiers, wetting agents and tackifiers), and if appropriate further auxiliaries which are customary for formulating crop protection products. The person skilled in the art is sufficiently familiar with the recipes for such formulations. Further auxiliaries include e.g. organic and inorganic thickeners, bactericides, antifreeze agents, antifoams, colorants and, for seed formulations, adhesives.

Suitable carriers include liquid and solid carriers. Examples of the solid carrier used in formulation include fine powders or granules such as minerals such as kaolin clay, attapulgite clay, bentonite, montmorillonite, acid white clay, pyrophyllite, talc, diatomaceous earth and calcite; natural organic materials such as corn rachis powder and walnut husk powder; synthetic organic materials such as urea; salts such as calcium carbonate and ammonium sulfate; synthetic inorganic materials such as synthetic hydrated silicon oxide and the like. The liquid carrier include, aromatic hydrocarbons such as xylene, alkylbenzene and methylnaphthalene; alcohols such as 2-propanol, ethyleneglycol, propylene glycol, and ethylene glycol monoethyl ether; ketones such as acetone, cyclohexanone and isophorone; vegetable oil such as soybean oil and cotton seed oil; petroleum aliphatic hydrocarbons, esters, dimethylsulfoxide, acetonitrile and water and the like.

Examples of the surfactant include anionic surfactants such as alkyl sulfate ester salts, alkylaryl sulfonate salts, dialkyl sulfosuccinate salts, polyoxyethylene alkylaryl ether phosphate ester salts, lignosulfonate salts and naphthalene sulfonate formaldehyde polycondensates; and nonionic surfactants such as polyoxyethylene alkyl aryl ethers, polyoxyethylene alkylpolyoxypropylene block copolymers and sorbitan fatty acid esters and cationic surfactants such as alkyltrimethylammonium salts.

Examples of the other formulation auxiliary agents include water-soluble polymers such as polyvinyl alcohol and polyvinylpyrrolidone, polysaccharides such as Arabic gum, alginic acid and the salt thereof, CMC (carboxymethyl cellulose), xanthan gum, inorganic materials such as aluminum magnesium silicate and alumina sol, preservatives, coloring agents and stabilization agents such as PAP (acid phosphate isopropyl) and BHT.

The combinations of the present invention, for use in the methods of the present invention, may be used as a pre-mix composition or a kit of parts such that individual actives may be mixed before spraying.

In an embodiment, the constituents of the present combination for use in the method of the present disclosure may be tank mixed and sprayed at the locus of the infection or may be optionally mixed with surfactants and then sprayed.

In an embodiment, the present disclosure relates to a fungicidal composition comprising laminarin and an inorganic compound or its salts tank mixed with at least one non-ionic surfactant, for controlling phytopathogenic fungal diseases in cereal crops.

In an embodiment, the present disclosure relates to a fungicidal composition comprising laminarin and sulphur tank mixed with at least one non-ionic surfactant for controlling phytopathogenic fungal diseases in cereal crops.

In an embodiment, the non-ionic surfactant is hydrophilic.

In an embodiment, the non-ionic surfactant comprises fatty acids, ethoxylated fatty acids, fatty alcohols, ethoxylated fatty alcohols, polyethers and ethoxylated castor oil.

In an embodiment, the non-ionic surfactant comprises polyethers.

In an embodiment, the polyether comprises polyoxyethylene cetyl ethers, polyoxyethylene oleyl ethers, polyoxyethylene stearyl ethers, polyoxyethylene lauryl ethers, polyoxyethylene isocetyl ethers, polyoxyethylene isostearyl ethers, polyoxyethylene octydodecyl ethers, polyoxyethylene behenyl ethers, polyoxyethylene decyltetradecyl ethers, polyoxyethylene chloesteryl ethers, polyoxyethylene polyoxypropylene ethers.

The non-ionic surfactant includes ester type products including fatty acid esters, sorbitan fatty acid esters, fatty acid monoglycerides, fatty acid triglycerides, propylene glycol fatty acid esters, ethylene glycol fatty acid esters, and the like.

In an embodiment the ether-ester non-ionic materials include polyethyleneglycol monostearates, polyethyleneglycol monooleates, polyethyleneglycol monolaurate, polyoxyethylene hydrogenated castor oils, polyoxyethylene glyceryl monostearates, polyethyleneglycol monoisostearates, polyoxyethylene castor oils, polyoxyethylene cetyl ether stearates, polyoxyethylene stearyl ether stearates, polyoxyethylene lauryl ether stearates, polyoxyethylene lauryl ether isostearates, polyethyleneglycol dilaurates, polyethyleneglycol distearates, polyethyleneglycol diisostearates, polyethyleneglycol dioleates, polyethylene sorbitan fatty acid esters, and polyethylene sorbitan fatty acid esters, and the like.

In an embodiment, the polyether comprises polyoxyethylene lauryl ether.

In an embodiment, the ethoxylated fatty alcohol comprises polyethylene glycol stearates.

In a more preferred embodiment, the present disclosure relates to a fungicidal composition comprising laminarin and sulphur or its salts, tank-mixed with one or more polyethylene glycol stearates.

In a more preferred embodiment, the present disclosure relates to a fungicidal composition comprising laminarin and sulphur or its salts, tank-mixed with polyethylene glycol stearates.

In an embodiment, the non-ionic surfactant is in a concentration ranging from 1 to 70 g/L.

In an embodiment, the non-ionic surfactant is in a concentration ranging from 5 to 60 g/L.

In an embodiment, the non-ionic surfactant is in a concentration ranging from 10 to 45 g/L.

In an embodiment, the non-ionic surfactant is in a concentration of 20 g/L.

In an embodiment, the non-ionic surfactant is in a concentration of 15 g/L.

In an embodiment, the non-ionic surfactant is in a concentration of 10 g/L.

In an embodiment, the polyethylene glycol stearate is in a concentration ranging from 1 to 70 g/L.

In an embodiment, the polyethylene glycol stearate is in a concentration ranging from 5 to 60 g/L.

In an embodiment, the polyethylene glycol stearate is in a concentration ranging from 10 to 45 g/L.

In an embodiment, the polyoxyethylene lauryl ether is in a concentration ranging from 1 to 70 g/L.

In an embodiment, the polyoxyethylene lauryl ether is in a concentration ranging from 5 to 60 g/L.

In an embodiment, the polyoxyethylene lauryl ether is in a concentration ranging from 10 to 45 g/L.

In an embodiment, the polyoxyethylene lauryl ether is in a concentration of 20 g/L.

In an embodiment, the polyoxyethylene lauryl ether is in a concentration of 15 g/L.

In an embodiment, the polyoxyethylene lauryl ether is in a concentration of 10 g/L.

An embodiment of the present disclosure provides a kit comprising:
(i) laminarin, and
(ii) a second fungicidal component comprising at least one contact fungicide selected from sulphur, dithiocarbamates such as mancozeb, phthalimides such as captan and chloronitriles such as chlorothalonil.

Another embodiment of the present disclosure provides a kit comprising:
(i) laminarin, and
(ii) a second fungicidal component comprising sulphur.

Another embodiment of the present disclosure provides a kit comprising:
(i) laminarin,
(ii) sulphur, and
(iii) a non-ionic surfactant comprising fatty acids, ethoxylated fatty acids, polyethers, fatty alcohols, ethoxylated fatty alcohols and ethoxylated castor oil.

Another embodiment of the present disclosure provides a kit comprising:
(i) laminarin,
(ii) a second fungicidal component comprising sulphur, and
(iii) an additional agrochemical comprising a fungicide.

Another embodiment of the present disclosure provides a kit comprising:
(i) laminarin,
(ii) a second fungicidal component comprising sulphur,
(iii) an additional agrochemical comprising a fungicide, and
(iv) a non-ionic surfactant comprising fatty acids, ethoxylated fatty acids, polyether, fatty alcohols, ethoxylated fatty alcohols and ethoxylated castor oil.

Another embodiment of the present disclosure provides a kit comprising:
(i) a composition comprising laminarin and sulphur, and
(ii) a non-ionic surfactant comprising fatty acids, ethoxylated fatty acids, fatty alcohols, ethoxylated fatty alcohols and ethoxylated castor oil.

In an embodiment, the present invention relates to the use of combinations comprising a β-1,3-glucan polysaccharide and at least one contact fungicide for controlling phytopathogenic fungal diseases in cereal crops

In an embodiment, the present disclosure provides use of fungicidal combinations comprising laminarin and at least one contact fungicide for controlling phytopathogenic fungal diseases in cereal crops.

In an embodiment, the present disclosure provides use of fungicidal combinations comprising laminarin and at least one contact fungicide for controlling phytopathogenic fungal diseases in wheat crops.

In an embodiment, the present disclosure provides use of fungicidal combinations comprising laminarin and at least one contact fungicide for controlling phytopathogenic fungal diseases in rice crops.

In an embodiment, the present disclosure provides use of fungicidal combinations comprising laminarin and an inorganic compound for controlling phytopathogenic fungal diseases in cereal crops.

In an embodiment, the present disclosure provides use of fungicidal combinations comprising laminarin and an inorganic compound for controlling phytopathogenic fungal diseases in wheat crops.

In an embodiment, the present disclosure provides use of fungicidal combinations comprising laminarin and an inorganic compound for controlling phytopathogenic fungal diseases in rice crops.

In an embodiment, the present disclosure provides use of fungicidal combinations comprising laminarin and sulphur for controlling phytopathogenic fungal diseases in cereal crops.

In an embodiment, the present disclosure provides use of fungicidal combinations comprising laminarin and sulphur for controlling phytopathogenic fungal diseases in wheat crops.

In an embodiment, the present disclosure provides use of fungicidal combinations comprising laminarin and sulphur for controlling phytopathogenic fungal diseases in rice crops.

In an embodiment, the present disclosure provides use of a fungicidal combination comprising laminarin and sulphur for controlling Zymoseptoria sp, Zymoseptoria triitici, Puccinia striiformis, Puccinia sp, Pyricularia sp. Pyricularia oryzae in cereal crops.

In an embodiment, the present disclosure provides use of fungicidal combinations comprising laminarin and sulphur for controlling Septoria leaf blotch in cereal crops.

In an embodiment, the present disclosure provides use of fungicidal combinations comprising laminarin and sulphur for controlling Septoria leaf blotch in wheat crops.

In an embodiment, the present disclosure provides use of fungicidal combinations comprising laminarin and sulphur for controlling Zymoseptoria tritici in cereal crops.

In an embodiment, the present disclosure provides use of fungicidal combinations comprising laminarin and sulphur for controlling Zymoseptoria tritici in wheat crops.

In an embodiment, the present disclosure provides use of fungicidal combinations comprising laminarin and sulphur for controlling Puccinia striiformis in cereal crops.

In an embodiment, the present disclosure provides use of fungicidal combinations comprising laminarin and sulphur for controlling Puccinia striiformis in wheat crops.

In an embodiment, the present disclosure provides use of fungicidal combinations comprising laminarin and sulphur for controlling Pyricularia oryzae in cereal crops.

In an embodiment, the present disclosure provides use of fungicidal combinations comprising laminarin and sulphur for controlling Pyricularia oryzae in rice crops.

In an embodiment, the present disclosure provides use of fungicidal combinations comprising laminarin and sulphur tank-mixed with a non-ionic surfactant for controlling phytopathogenic fungal diseases in cereal crops.

In an embodiment, the present disclosure provides use of fungicidal combinations comprising laminarin and sulphur tank-mixed with a non-ionic surfactant for controlling phytopathogenic fungal diseases in wheat crops.

In an embodiment, the present disclosure provides use of fungicidal combinations comprising laminarin and sulphur tank-mixed with a non-ionic surfactant for controlling phytopathogenic fungal diseases in rice crops.

In an embodiment, the present disclosure provides use of fungicidal combinations comprising laminarin and sulphur tank-mixed with polyethylene glycol stearate for controlling phytopathogenic fungal diseases in cereal crops.

In an embodiment, the present disclosure provides use of fungicidal combinations comprising laminarin and sulphur tank-mixed with polyethylene glycol stearate for controlling phytopathogenic fungal diseases in wheat crops.

In an embodiment, the present disclosure provides use of fungicidal combinations comprising laminarin and sulphur tank-mixed with polyethylene glycol stearate for controlling phytopathogenic fungal diseases in rice crops.

In an embodiment, the present disclosure provides use of fungicidal combinations comprising laminarin and sulphur tank-mixed with polyoxyethylene lauryl ether for controlling phytopathogenic fungal diseases in cereal crops.

In an embodiment, the present disclosure provides use of fungicidal combinations comprising laminarin and sulphur tank-mixed with polyoxyethylene lauryl ether for controlling phytopathogenic fungal diseases in wheat crops.

In an embodiment, the present disclosure provides use of fungicidal combinations comprising laminarin and sulphur tank-mixed with polyoxyethylene lauryl ether for controlling phytopathogenic fungal diseases in rice crops.

In an embodiment, the present invention relates to the use of compositions comprising a β-1,3-glucan polysaccharide, at least one contact fungicide and at least one agrochemically acceptable excipient for controlling phytopathogenic fungal diseases in cereal crops.

In an embodiment, the present disclosure provides use of a fungicidal composition comprising laminarin, at least one contact fungicide and at least one agrochemically acceptable excipient for controlling phytopathogenic fungal diseases in cereal crops.

In an embodiment, the present disclosure provides use of a fungicidal composition comprising laminarin, at least one contact fungicide and at least one agrochemically acceptable excipient for controlling phytopathogenic fungal diseases in wheat crops.

In an embodiment, the present disclosure provides use of a fungicidal composition comprising laminarin, at least one contact fungicide and at least one agrochemically acceptable excipient for controlling phytopathogenic fungal diseases in rice crops.

In an embodiment, the present disclosure provides use of a fungicidal composition comprising laminarin, at least one inorganic compound and at least one agrochemically acceptable excipient for controlling phytopathogenic fungal diseases in cereal crops.

In an embodiment, the present disclosure provides use of a fungicidal composition comprising laminarin, at least one inorganic compound and at least one agrochemically acceptable excipient for controlling phytopathogenic fungal diseases in wheat crops.

In an embodiment, the present disclosure provides use of a fungicidal composition comprising laminarin, at least one inorganic compound and at least one agrochemically acceptable excipient for controlling phytopathogenic fungal diseases in rice crops.

In an embodiment, the present disclosure provides use of a fungicidal composition comprising laminarin, sulphur and at least one agrochemically acceptable excipient for controlling phytopathogenic fungal diseases in cereal crops.

In an embodiment, the present disclosure provides use of a fungicidal composition comprising laminarin, sulphur and at least one agrochemically acceptable excipient for controlling phytopathogenic fungal diseases in wheat crops.

In an embodiment, the present disclosure provides use of a fungicidal composition comprising laminarin, sulphur and at least one agrochemically acceptable excipient for controlling phytopathogenic fungal diseases in rice crops.

In an embodiment, the present disclosure provides use of a fungicidal composition comprising laminarin, sulphur and at least one agrochemically acceptable excipient for controlling Septoria leaf blotch in cereal crops.

In an embodiment, the present disclosure provides use of a fungicidal composition comprising laminarin, sulphur and at least one agrochemically acceptable excipient for controlling Septoria leaf blotch in wheat crops.

In an embodiment, the present disclosure provides use of a fungicidal composition comprising laminarin, sulphur and at least one agrochemically acceptable excipient for controlling Zymoseptoria sp, Zymoseptoria triitici, Puccinia striiformis, Puccinia sp, Pyricularia sp. Pyricularia oryzae in cereal crops.

In an embodiment, the present disclosure provides use of a fungicidal composition comprising laminarin, sulphur and at least one agrochemically acceptable excipient tank mixed with a non-ionic surfactant for controlling phytopathogenic fungal diseases in cereal crops.

In an embodiment, the present disclosure provides use of a fungicidal composition comprising laminarin, sulphur and at least one agrochemically acceptable excipient tank mixed with a non-ionic surfactant for controlling phytopathogenic fungal diseases in wheat crops.

In an embodiment, the present disclosure provides use of a fungicidal composition comprising laminarin, sulphur and at least one agrochemically acceptable excipient tank mixed with a non-ionic surfactant for controlling phytopathogenic fungal diseases in rice crops.

In an embodiment, the present disclosure provides use of a fungicidal composition comprising laminarin, sulphur and at least one agrochemically acceptable excipient tank mixed with a non-ionic surfactant for controlling Septoria leaf blotch in cereal crops.

In an embodiment, the present disclosure provides use of a fungicidal composition comprising laminarin, sulphur and at least one agrochemically acceptable excipient tank mixed with a non-ionic surfactant for controlling Septoria leaf blotch in wheat crops.
In an embodiment, the present disclosure provides use of a fungicidal composition comprising laminarin, sulphurand at least one agrochemically acceptable excipient tank mixed with a non-ionic surfactant for controlling Zymoseptoria sp, Zymoseptoria triitici, Puccinia striiformis, Puccinia sp, Pyricularia sp. Pyricularia oryzae in cereal crops.

In an embodiment, the constituents of the combination/composition for use in the methods of the present disclosure may be tank mixed and sprayed at the locus of the infection or may be alternatively mixed with surfactants and then sprayed.

In an embodiment, the constituents of the combination/composition for use in the methods of the present disclosure may be used for foliar application, ground or applications to plant propagation materials.

It is readily understood that the method of treatment of the present disclosure may be used on all plants that are infected by fungi. Such exemplary host plants may include cereal plants for example wheat.

In an embodiment, these combinations or compositions of the present disclosure may be especially effective against Septoria family of fungi.

In an embodiment the present disclosure provides a fungicidal combination and a composition comprising fungicidally effective amount of laminarin and a contact fungicide, preferably sulphur for controlling Zymoseptoria infection in a host plant.

In preferred embodiment there is provided method of treatment of phytopathogenic infection caused by Septoria sp. in wheat plants. For example, the Zymoseptoria fungus include species, Zymoseptoria ardabiliae, Zymoseptoria brevis, Zymoseptoria halophila, Zymoseptoria passerinii, Zymoseptoria pseudotritici, Zymoseptoria tritici and Zymoseptoria verkleyi.

In preferred embodiment there is provided method of treatment of phytopathogenic infection caused by Puccinia sp. wheat plants.

In another embodiment, the method of controlling fungal diseases in plants comprises applying to a locus a fungicidally effective amount of laminarin and a contact fungicide comprising at least one contact fungicide selected from an inorganic compound, sulphur, copper or its salts, dithiocarbamates such as mancozeb, phthalimides such as captan and chloronitriles such as chlorothalonil or combinations thereof.

In an embodiment, the present method comprises treating the cereal plants with a fungicidally effective amount of a combination comprising laminarin and an inorganic compound.

In an embodiment, the method of controlling fungal diseases in plants comprises treating cereal crops with a fungicidally effective amount of a combination comprising laminarin and an inorganic compound or its salts.

In a preferred embodiment, the method of controlling fungal diseases in plants comprises applying to a locus a fungicidally effective amount of a combination comprising laminarin and sulphur.

In an embodiment, the method of controlling fungal diseases in plants comprises applying to a locus a fungicidally effective amount of a combination comprising laminarin and a copper or its salts comprising tribasic copper sulphate, copper oxychloride, copper sulphate and such other salts of copper.

In a preferred embodiment, the method of controlling fungal diseases in plants comprises applying to a locus a fungicidally effective amount of a combination comprising laminarin and copper and its salts.

In a preferred embodiment, the present method comprises treating cereal plants with a fungicidally effective amount of a combination comprising laminarin and sulphur.

Typically, the combinations or compositions and methods of the present disclosure are for the treatment and/or controlling Septoria leaf blotch or speckled leaf blotch of wheat, Zymoseptoria tritici.

In an embodiment, the method for controlling fungal diseases comprises treating seeds with a fungicidally effective amount of laminarin and a contact fungicide selected from inorganic compounds such as sulphur or copper or salts thereof, dithiocarbamates such as mancozeb, phthalimides such as captan and chloronitriles such as chlorothalonil or combinations thereof.

In an embodiment, the method for controlling fungal diseases comprises treating seeds with a fungicidally effective amount of a combination comprising laminarin and sulphur.

In another embodiment, the method for controlling fungal diseases comprises treating cereals seeds with a fungicidally effective amount of laminarin and sulphur.

In an embodiment, the cereal crops comprise wheat, maize, rice, barley, oats, rye and sorghum.

In an embodiment, the cereal plants and seeds comprise wheat and triticale.

In an embodiment, the composition of the present disclosure is an emulsifiable concentrate.

In an embodiment, the composition of the present disclosure is a suspension concentrate.

In a preferred embodiment the suspension concentrate of the present disclosure comprises each active of laminarin and sulphur in an amount in the range of 10 g/L to 800 g/L.

In an embodiment the effective amount of active ingredient of laminarin is preferably 1% to 90% by weight, in particular 1% to 80% by weight of the total weight of the composition.

In an embodiment the effective amount of active ingredient of sulphur is preferably 0.01% to 80% by weight, in particular 0.01% to 60% by weight of the composition.

In a preferred embodiment, suspension concentrate composition is used for controlling Septoria titrici in cereal plants for example wheat plants.

In an embodiment, the method of controlling fungi comprises applying laminarin and sulphur as a tank mix.

In an embodiment, the method of controlling fungi comprises applying laminarin and sulphur as a premix.

In an embodiment, the method of controlling fungi comprises applying laminarin and sulphur in immediate succession.

In an embodiment, the method of controlling fungi comprises applying a fungicidal combination comprising laminarin and sulphur to a locus, wherein laminarin is in an amount ranging from 5 to 50 g/ha and a contact fungicide in an amount ranging from 200 to 1000 g/ha.

In an embodiment, the method of controlling fungi comprises applying a fungicidal combination comprising laminarin and sulphur to a locus, wherein laminarin is in an amount ranging from 5 to 45 g/ha and a contact fungicide in an amount ranging from 200 to 800 g/ha.

In an embodiment, the method of controlling fungi comprises applying a fungicidal combination comprising laminarin and sulphur to a locus, wherein laminarin is in an amount ranging from 5 to 45 g/ha and a contact fungicide in an amount ranging from 400 to 800 g/ha.

In an embodiment, the method of controlling fungi comprises applying a fungicidal combination comprising laminarin and sulphur to a locus, wherein laminarin is in an amount ranging from 5 to 50 g/ha and an inorganic compound in an amount ranging from 200 to 1000 g/ha.

In an embodiment, the method of controlling fungi comprises applying a fungicidal combination comprising laminarin and sulphur to a locus, wherein laminarin in an amount ranging from 5 to 45 g/ha and an inorganic compound in an amount ranging from 200 to 800 g/ha.

In an embodiment, the method of controlling fungi comprises applying a fungicidal combination comprising laminarin and sulphur to a locus, wherein laminarin in an amount ranging from 5 to 45 g/ha and an inorganic compound in an amount ranging from 400 to 800 g/ha.

In an embodiment, the method of controlling fungi comprises applying a fungicidal combination comprising laminarin and sulphur to a locus, wherein laminarin in an amount ranging from 5 to 50 g/ha and sulphur in an amount ranging from 200 to 1000 g/ha.

In an embodiment, the method of controlling fungi comprises applying a fungicidal combination comprising laminarin and sulphur to a locus, wherein laminarin in an amount ranging from 5 to 45 g/ha and sulphur in an amount ranging from 200 to 800 g/ha.

In an embodiment, the method of controlling fungi comprises applying a fungicidal combination comprising laminarin and sulphur to a locus, wherein laminarin in an amount ranging from 5 to 45 g/ha and sulphur in an amount ranging from 400 to 800 g/ha.

In an embodiment, the method of controlling fungi comprises applying a fungicidal combination comprising laminarin and sulphur to a locus, wherein laminarin and sulphur at a rate ranging from 0.1 to 8 L/ha, preferably in an amount ranging from 0.5 L/ha to 5.0 L/ha, preferred being 1 L/ha to 4 L/ha.

In an embodiment, the present disclosure provides a method of controlling Septoria leaf spot disease in cereals, preferably in wheat by applying a fungicidal combination comprising laminarin and sulphur at a rate ranging from 0.1 to 8 L/ha, preferably in an amount ranging from 0.5 L/ha to 5.0 L/ha, preferred being 1 L/ha to 4 L/ha.

In an embodiment, the present disclosure provides a method of controlling fungal diseases in rice crop by applying a fungicidal combination comprising laminarin and sulphur at a rate ranging from 0.1 to 8 L/ha, preferably in an amount ranging from 0.5 L/ha to 5.0 L/ha, preferred being 1 L/ha to 4 L/ha.

In an embodiment, the present disclosure provides a method of controlling fungi comprises applying a fungicidal combination comprising laminarin and a contact fungicide tank-mixed with a non-ionic surfactant for controlling phytopathogenic fungal diseases in cereal crops.

In an embodiment, the present disclosure provides method of controlling fungi comprises applying a fungicidal combination comprising laminarin and an inorganic compound tank-mixed with a non-ionic surfactant for controlling phytopathogenic fungal diseases in cereal crops.

In an embodiment, the present disclosure provides a method of controlling fungi comprises applying a fungicidal combination comprising laminarin and sulphur tank-mixed with a non-ionic surfactant for controlling phytopathogenic fungal diseases in cereal crops.

In an embodiment, the present disclosure provides a method of controlling fungi comprises applying a fungicidal combination comprising laminarin and sulphur tank-mixed with a non-ionic surfactant for controlling phytopathogenic fungal diseases in wheat crops.

In an embodiment, the non-ionic surfactant selected from the group comprising comprises fatty acids, ethoxylated fatty acids, polyethers, fatty alcohols, polyethoxylated fatty alcohols and ethoxylated castor oil, wherein the non-ionic surfactant comprises a polyoxyethylene lauryl ether.

In an embodiment, the present disclosure provides a method of controlling fungi comprises applying a fungicidal combination comprising laminarin and sulphur tank-mixed with a non-ionic surfactant for controlling phytopathogenic fungal diseases in rice crops.

In an embodiment, the present disclosure provides a method of controlling fungi comprises applying a fungicidal combination comprising laminarin and sulphur tank-mixed with polyoxyethylene lauryl ether for controlling phytopathogenic fungal diseases in cereal crops.

In an embodiment, the present disclosure provides a method of controlling fungi comprises applying a fungicidal combination comprising laminarin and sulphur tank-mixed with polyoxyethylene lauryl ether for controlling phytopathogenic fungal diseases in wheat crops.

In an embodiment, the present disclosure provides a method of controlling fungi comprises applying a fungicidal combination comprising laminarin and sulphur tank-mixed with polyoxyethylene lauryl ether for controlling phytopathogenic fungal diseases in rice crops.

In an embodiment, the method of controlling fungi comprises applying a fungicidal combination comprising A) laminarin and a contact fungicide and B) a non-ionic surfactant to a locus, wherein components A) and B are applied as a tank-mix at a rate ranging from 0.1 to 8 L/ha, preferably in an amount ranging from 0.5 L/ha to 5.0 L/ha, preferred being 1 L/ha to 4 L/ha.

In an embodiment, the method of controlling fungi comprises applying a fungicidal combination comprising A) laminarin and a contact fungicide and B) an inorganic compound to a locus, wherein components A) and B are applied as a tank-mix at a rate ranging from 0.1 to 8 L/ha, preferably in an amount ranging from 0.5 L/ha to 5.0 L/ha, preferred being 1 L/ha to 4 L/ha.

In an embodiment, the method of controlling fungi comprises applying a fungicidal combination comprising A) laminarin and sulphur and B) a non-ionic surfactant to a locus, wherein components A) and B are applied as a tank-mix at a rate ranging from 0.1 to 8 L/ha, preferably in an amount ranging from 0.5 L/ha to 5.0 L/ha, preferred being 1 L/ha to 4 L/ha.

In an embodiment, the present disclosure provides a method of controlling fungal diseases in cereals, by applying a fungicidal combination comprising A) laminarin and sulphur and B) polyoxyethylene lauryl ether to a locus, wherein components A) and B are applied as a tank-mix at a rate ranging from 0.1 to 8 L/ha, preferably in an amount ranging from 0.5 L/ha to 5.0 L/ha, preferred being 1 L/ha to 4 L/ha.

In an embodiment, the present disclosure provides a method of controlling Septoria leaf spot disease in cereals, preferably in wheat by applying a fungicidal combination comprising A) laminarin and sulphur and B) polyoxyethylene lauryl ether to a locus, wherein components A) and B are applied as a tank-mix at a rate ranging from 0.1 to 8 L/ha, preferably in an amount ranging from 0.5 L/ha to 5.0 L/ha, preferred being 1 L/ha to 4 L/ha.

In an embodiment, the present disclosure provides a method of controlling Septoria leaf spot disease in rice crop by applying a fungicidal combination comprising A) laminarin and sulphur and B) polyoxyethylene lauryl ether to a locus, wherein components A) and B are applied as a tank-mix at a rate ranging from 0.1 to 8 L/ha, preferably in an amount ranging from 0.5 L/ha to 5.0 L/ha, preferred being 1 L/ha to 4 L/ha.

In an embodiment, the method of controlling fungi comprises applying a fungicidal composition comprising laminarin and sulphur to a locus, wherein laminarin is in an amount ranging from 5 to 50 g/ha and a contact fungicide in an amount ranging from 200 to 1000 g/ha.

In an embodiment, the method of controlling fungi comprises applying a fungicidal composition comprising laminarin and sulphur to a locus, wherein laminarin is in an amount ranging from 5 to 45 g/ha and a contact fungicide in an amount ranging from 200 to 800 g/ha.

In an embodiment, the method of controlling fungi comprises applying a fungicidal composition comprising laminarin and sulphur to a locus, wherein laminarin is in an amount ranging from 5 to 45 g/ha and a contact fungicide in an amount ranging from 400 to 800 g/ha.

In an embodiment, the method of controlling fungi comprises applying a fungicidal composition comprising laminarin and sulphur to a locus, wherein laminarin is in an amount ranging from 5 to 50 g/ha and an inorganic compound in an amount ranging from 200 to 1000 g/ha.

In an embodiment, the method of controlling fungi comprises applying a fungicidal composition comprising laminarin and sulphur to a locus, wherein laminarin in an amount ranging from 5 to 45 g/ha and an inorganic compound in an amount ranging from 200 to 800 g/ha.

In an embodiment, the method of controlling fungi comprises applying a fungicidal composition comprising laminarin and sulphur to a locus, wherein laminarin in an amount ranging from 5 to 45 g/ha and an inorganic compound in an amount ranging from 400 to 800 g/ha.

In an embodiment, the method of controlling fungi comprises applying a fungicidal composition comprising laminarin and sulphur to a locus, wherein laminarin in an amount ranging from 5 to 50 g/ha and sulphur in an amount ranging from 200 to 1000 g/ha.

In an embodiment, the method of controlling fungi comprises applying a fungicidal composition comprising laminarin and sulphur to a locus, wherein laminarin in an amount ranging from 5 to 45 g/ha and sulphur in an amount ranging from 200 to 800 g/ha.

In an embodiment, the method of controlling fungi comprises applying a fungicidal composition comprising laminarin and sulphur to a locus, wherein laminarin in an amount ranging from 5 to 45 g/ha and sulphur in an amount ranging from 400 to 800 g/ha.

In an embodiment, the method of controlling fungi comprises applying a fungicidal composition comprising laminarin and sulphur to a locus, wherein laminarin and sulphur in an amount ranging from 0.5 L/ha to 5.0 L/ha, preferred being 1 L/ha to 4 L/ha.

In an embodiment, the present disclosure provides a method of controlling Septoria leaf spot disease in cereals, preferably in wheat by applying a fungicidal composition comprising laminarin and sulphur in an amount ranging from 0.5 L/ha to 5.0 L/ha, preferred being 1 L/ha to 4 L/ha.

In an embodiment, the present disclosure provides a method of controlling fungal diseases in plants by applying a fungicidal composition comprising laminarin and sulphur at a rate ranging from 0.5 L/ha to 5.0 L/ha, preferred being 1 L/ha to 4 L/ha.

In an embodiment, the present disclosure provides a method of controlling Septoria leaf spot disease in cereals, preferably in wheat by applying a fungicidal composition comprising laminarin and sulphur at a rate ranging from 0.5 L/ha to 5.0 L/ha, preferred being 1 L/ha to 4 L/ha.

In an embodiment, the present disclosure provides a method of controlling fungi comprises applying a fungicidal composition comprising laminarin and a contact fungicide tank-mixed with a non-ionic surfactant for controlling phytopathogenic fungal diseases in cereal crops.

In an embodiment, the present disclosure provides method of controlling fungi comprises applying a fungicidal composition comprising laminarin and an inorganic compound tank-mixed with a non-ionic surfactant for controlling phytopathogenic fungal diseases in cereal crops.

In an embodiment, the present disclosure provides a method of controlling fungi comprises applying a fungicidal composition comprising laminarin and sulphur tank-mixed with a non-ionic surfactant for controlling phytopathogenic fungal diseases in cereal crops.

In an embodiment, the present disclosure provides a method of controlling fungi comprises applying a fungicidal composition comprising laminarin and sulphur tank-mixed with a non-ionic surfactant for controlling phytopathogenic fungal diseases in wheat crops.

In an embodiment, the non-ionic surfactant selected from the group comprising comprises fatty acids, ethoxylated fatty acids, polyethers, fatty alcohols, polyethoxylated fatty alcohols and ethoxylated castor oil, wherein the non-ionic surfactant comprises a polyoxyethylene lauryl ether.

In an embodiment, the present disclosure provides a method of controlling fungi comprises applying a fungicidal composition comprising laminarin and sulphur tank-mixed with a non-ionic surfactant for controlling phytopathogenic fungal diseases in rice crops.

In an embodiment, the method of controlling fungi comprises applying a fungicidal composition comprising A) laminarin and a contact fungicide and B) a non-ionic surfactant to a locus, wherein components A) and B are applied as a tank-mix at a rate ranging from 0.1 to 8 L/ha, preferably in an amount ranging from 0.5 L/ha to 5.0 L/ha, preferred being 1 L/ha to 4 L/ha.

In an embodiment, the method of controlling fungi comprises applying a fungicidal composition comprising A) laminarin and a contact fungicide and B) an inorganic compound to a locus, wherein components A) and B are applied as a tank-mix at a rate ranging from 0.1 to 8 L/ha, preferably in an amount ranging from 0.5 L/ha to 5.0 L/ha, preferred being 1 L/ha to 4 L/ha.

In an embodiment, the method of controlling fungi comprises applying a fungicidal composition comprising A) laminarin and sulphur and B) a non-ionic surfactant to a locus, wherein components A) and B are applied as a tank-mix at a rate ranging from 0.1 to 8 L/ha, preferably in an amount ranging from 0.5 L/ha to 5.0 L/ha, preferred being 1 L/ha to 4 L/ha.

In an embodiment, the present disclosure provides a method of controlling fungal diseases in cereals, by applying a fungicidal composition comprising A) laminarin and sulphur and B) polyoxyethylene lauryl ether to a locus, wherein components A) and B are applied as a tank-mix at a rate ranging from 0.1 to 8 L/ha, preferably in an amount ranging from 0.5 L/ha to 5.0 L/ha, preferred being 1 L/ha to 4 L/ha.

In an embodiment, the present disclosure provides a method of controlling Septoria leaf spot disease in cereals, preferably in wheat by applying a fungicidal composition comprising A) laminarin and sulphur and B) polyoxyethylene lauryl ether to a locus, wherein components A) and B are applied as a tank-mix at a rate ranging from 0.1 to 8 L/ha, preferably in an amount ranging from 0.5 L/ha to 5.0 L/ha, preferred being 1 L/ha to 4 L/ha.

In an embodiment, the present disclosure provides a method of controlling Septoria leaf spot disease in rice crop by applying a fungicidal composition comprising A) laminarin and sulphur and B) polyoxyethylene lauryl ether to a locus, wherein components A) and B are applied as a tank-mix at a rate ranging from 0.1 to 8 L/ha, preferably in an amount ranging from 0.5 L/ha to 5.0 L/ha, preferred being 1 L/ha to 4 L/ha.

The aforesaid embodiments narrated above are meant to refer to method of controlling fungal diseases in wheat, maize, rice, barley, oats, rye and sorghum.

In some embodiments, the present composition comprising laminarin and sulphur may also be used together with fertilizers such as ammonium nitrate, urea, potash, and superphosphate, phytotoxicants and plant growth regulators and safeners. These may be used sequentially or in combination with the above-described compositions, if appropriate also added immediately prior to use (tank mix) and the plant(s) may be sprayed with a composition of this invention either before or after being treated with the fertilizers.

In accordance with present disclosure the method of control of target fungi may be carried out by spraying the suggested tank mixes, or the individual herbicides may be formulated as a kit-of-parts containing various components that may be mixed as instructed prior to spraying.

It is readily understood that the method of treatment of the present disclosure may be used on all host plants that are infected by Zymoseptoria species, Puccinia species, and Pyricularia species. Such exemplary host plants may include cereal plants, their seeds or the soil.

Accordingly, the compositions described herein can control a broad spectrum of plant diseases in crops including: cereal grain crops such as wheat, barley, oats, rye, triticale, rice, maize, sorghum and millet; vine crops such as table and wine grapes; field crops such as oilseed rape (canola), sunflower; sugar beets, sugar cane, soybean, peanuts (groundnut), tobacco, alfafa, clover, lespedeza, trefoil and vetch; pome fruits such as apple, pear, crabapple, loquat, mayhaw and quince; stone fruits such as peaches, cherries, plums, apricots, nectarines and almonds; citrus fruits such as lemons, limes, oranges, grapefruit, mandarin (tangerines) and kumquat; root and tuber vegetables and field crops (and their foliage) such as artichoke, garden and sugar beet, carrot, cassaya, ginger, ginseng, horseradish, parsnip, potato, radish, rutabaga, sweet potato, turnip and yam; bulb vegetables such as garlic, leek, onion and shallot; leafy vegetables such as arugula (roquette), celery, celery, cress, endive (escarole), fennel, head and leaf lettuce, parsley, radicchio (red chicory), rhubarb, spinach and Swiss chard; brassica (cole) leafy vegetables such as broccoli, broccoli raab (rapini), Brussels sprouts, cabbage, bok Choy, cauliflower, collards, kale, kohlrabi, mustard and greens; legume vegetables (succulent or dried) such as lupin, bean (Phaseolus spp.) (including field bean, kidney bean, lima bean, navy bean, pinto bean, runner bean, snap bean, tepary bean and wax bean), bean (Vigna spp.) (including adzuki bean, asparagus bean, blackeyed pea, catjang, Chinese longbean, cowpea, crowder pea, moth bean, mung bean, rice bean, southern pea, urd bean and yardlong bean), broad bean (fava), chickpea (garbanzo), guar, jackbean, lablab bean, lentil and pea (Pisum spp.) (including dwarf pea, edible-podded pea, English pea, field pea, garden pea, green pea, snowpea, sugar snap pea, pigeon pea and soybean); fruiting vegetables such as eggplant, groundcherry (Physalis spp.), pepino and pepper (including bell pepper, chili pepper, cooking pepper, pimento, sweet pepper; tomatillo and tomato); cucurbit vegetables such as Chayote (fruit), Chinese waxgourd (Chinese preserving melon), citron melon, cucumber, gherkin, edible gourd (including hyotan, cucuzza, hechima, and Chinese okra), Momordica spp. (including balsam apple, balsam pear, bittermelon and Chinese cucumber), muskmelon (including cantaloupe and pumpkin), summer and winter squash (including butternut squash, calabaza, hubbard squash, acorn squash, spaghetti squash) and watermelon; berries such as blackberry (including bingleberry, boysenberry, dewberry, lowberry, marionberry, olallieberry and youngberry), blueberry, cranberry, currant, elderberry, gooseberry, huckleberry, loganberry, raspberry and strawberry; tree nuts such as almond, beech nut, Brazil nut, butternut, cashew, chestnut, chinquapin, filbert (hazelnut), hickory nut, macadamia nut, pecan and walnut; tropical fruits and other crops such as bananas, plantains, mangos, coconuts, papaya, guava, avocado, lichee, agave, coffee, cacao, sugar cane, oil palm, sesame, rubber and spices; fiber crops such as cotton, flax and hemp; turfgrasses (including warm- and cool-season turfgrasses) such as bentgrass, Kentucky bluegrass, St. Augustine grass, tall fescue and Bermuda grass.

The method of controlling fungi according to the present disclosure may be used to control a broad spectrum of plant diseases, such as: Disease in rice: Blast (Magnaporthe grisea), Helminthosporium leaf spot (Cochliobolus miyabeanus), sheath blight (Rhizoctonia solani), and bakanae disease (Gibberella fujikuroi).

Diseases in wheat: powdery mildew (Erysiphe graminis), Fusarium head blight (Fusarium graminearum, F. avenacerum, F. culmorum, Microdochium nivale), rust (Puccinia striiformis, P. graminis, P. recondita), pink snow mold (Micronectriella nivale), Typhula snow blight (Typhula sp.), loose smut (Ustilago tritici), bunt (Tilletia caries), eyespot (Pseudocercosporella herpotrichoides), leaf blotch (Mycosphaerella graminicola), glume blotch (Stagonospora nodorum), septoria, and yellow spot (Pyrenophora tritici-repentis). Diseases of barley: powdery mildew (Erysiphe graminis), Fusarium head blight (Fusarium graminearum, F. avenacerum, F. culmorum, Microdochium nivale), rust (Puccinia striiformis, P. graminis, P. hordei), loose smut (Ustilago nuda), scald (Rhynchosporium secalis), net blotch (Pyrenophora teres), spot blotch (Cochliobolus sativus), leaf stripe (Pyrenophora graminea), and Rhizoctonia damping-off (Rhizoctonia solani).

Seed diseases or diseases in the early stages of the growth of various plants caused by Aspergillus spp., Penicillium spp., Fusarium spp., Gibberella spp., Tricoderma spp., Thielaviopsis spp., Rhizopus spp., Mucor spp., Corticium spp., Phoma spp., Rhizoctonia spp. and Diplodia spp.

Viral diseases of various plants mediated by Polymxa spp. or Olpidium spp. and so on. The method of the present disclosure also improves the existing disease control to an unexpectedly high degree and surprisingly improves the yield obtained. The method of the present disclosure also allows for greater resistance control and decreases the amount of the actives used.

The fungicide combinations/compositions of the present disclosure are highly safe to crop plants and capable of controlling target fungi problematic in e.g., paddy fields, upland fields or non-agricultural fields over a wide range of from pre-emergency to post-emergence.

The present disclosure is more particularly described in the following examples that are intended as illustration only, since numerous modifications and variations within the scope of the present disclosure will be apparent to those of skill in the art. Unless otherwise noted, all parts, percentages, and ratios reported in the following examples are on a weight basis, and all reagents used in the examples were obtained or are available from the chemical suppliers.

The following examples illustrates the composition, underlying effect and basic methodology of the present invention.

### EXAMPLES

### Example 1

Composition: Suspension concentrate (SC) formulation

Laminarin 10.8 g/L+Sulfur 733 g/L SC

TABLE 1

| Active ingredients | Concentration (%) w/w |
|---|---|
| laminarin concentrate | 10.28 |
| Elemental Sulfur | 50.68 |
| Glycerine | 6.40 |
| Sodium lignosulfonate | 6.00 |
| Polydimethylsiloxane | 0.20 |
| Citric acid | 0.40 |
| Sodium Benzoate | 0.40 |
| Potassium Sorbate | 0.40 |
| Xanthan gum | 0.10 |
| Water | Q.S. |
| Total | 100 |

The laminarin concentrate comprises laminarin and water, the content of laminarin present in the said concentrate ranges from 1 g/L to 15 g/L of the composition. In the context of the formulation presented above, the content of laminarin is 10.8 g/L.

Process: Laminarin concentrate was combined with water and other excipients. The dispersant sodium lignosulfonate was added slowly, ensuring rapid wetting to prevent clumping followed by addition of sulphur. The mixture was subjected to high shear agitation to ensure homogeneity and sample was then milled to d(0.5)<1 um. The thickener mixture was added to the millbase under low shear to finally obtain the desired formulation.

### Example 2

Composition: Suspension concentrate formulation

Laminarin 14.9 g/L+Sulfur 733 g/L SC

TABLE 2

| Active ingredients | Concentration (%) w/w |
|---|---|
| laminarin concentrate | 14.18 |
| Elemental Sulfur | 50.68 |
| Glycerine | 8.71 |
| Sodium lignosulfonate | 6.00 |
| Polydimethylsiloxane | 0.20 |
| Citric acid | 0.40 |
| Sodium Benzoate | 0.40 |
| Potassium Sorbate | 0.40 |
| Xanthan gum | 0.10 |
| Water | Q.S. |
| Total | 100 |

The laminarin concentrate comprises laminarin and water, the content of laminarin present in the said concentrate ranges from 1 g/L to 15 g/L of the composition. In the context of the formulation presented above, the content of laminarin is 14.9 g/L.

Process: Laminarin concentrate was combined with water and other excipients. The dispersant sodium lignosulfonate was added slowly, ensuring rapid wetting to prevent clumping followed by addition of sulphur. The mixture was subjected to high shear agitation to ensure homogeneity and sample was then milled to d (0.5)<lum. The thickener mixture was added to the millbase under low shear to finally obtain the desired formulation.

### Example 3: Efficacy of Laminarin and Sulphur Combination

The efficacy of the laminarin and sulphur combination was evaluated by determining the % disease control of Septoria tritici in wheat.

Protocol: The treatments used in this trial were applied 6 times, the time interval between each application is as follows: application ‘A’ was made at 0 days, ‘B’ is the application at 15 days after application ‘A’, ‘C’ is the application at 6 days after application ‘B’; ‘D’ is the application at 7 days after application ‘C’, ‘E’ is the application at 9 days after application ‘D’, and ‘F’ is the application made at ‘5’ days after application ‘E’. The application was made at a spray volume 150 L/ha. A tank mix consisting of sulphur in an amount of 4950 g a.i./ha and laminarin in an amount of 37 g a.i./ha was designated as treatment 4. Treatment 2 included sulphur in an amount of 4950 g a.i./ha, and treatment 3 included laminarin in an amount of 37 g a.i./ha. Infestation with the pathogen was natural.

The present combination of laminarin and sulphur was sprayed through foliar application at a rate of 3 l/ha. The observation of % control was made at the 5^{th} application (E).

A frequently used method for improving the use profile of an agrochemical is the combination of an active compound with one or more other active compounds which contribute to the desired additional properties. However, when two or more active compounds are applied in combination, it is not uncommon for phenomena of physical and biological incompatibility to occur, for example insufficient stability of a joint formulation, decomposition of an active compound or antagonism of the active compounds. What is desired are, in contrast, active compound combinations having a favorable activity profile, high stability and, if possible, synergistically enhanced activity, thus permitting the application rate to be reduced, compared with the individual application of the active compounds to be combined.

Chemical mixtures can have an antagonistic effect when mixed, where the results are less than expected when the chemicals are combined. There can also be an additive effect, where the resultant mixture gives results expected from the sum of its components. Finally, there can be a synergistic effect where the results are greater than expected. A synergistic result is rare and typically only observed in results from high concentrations. In the heavily regulated agrochemical industry, high concentrations are not desirable in the environment. Therefore, when a synergistic effect is achieved at low doses, the resultant mixture is indeed a rare and unexpected finding.

A synergistic effect of an agrochemical is always present when the anti-phytopathogenic activity of the active compound combinations exceeds the total of the activities of the active compounds when applied individually. The expected activity for a given combination of two active compounds can be calculated according to S. R. Colby (“Calculating Synergistic and Antagonistic Responses of Herbicide Combinations”, Weeds 15, (1967), 20-22).

This effectiveness of all treatments as measured by percent reduction in the Septoria tritici in wheat, was also evaluated according to Colby's equation as below.

If,
X is the percent inhibition of growth by sulphur (A) at an application rate,
Y is the percent inhibition of growth by laminarin (B) at an application rate, and
E is the expected growth as a percent of control with sulphur and laminarin when applying the active compounds, A and B at application rates

Then,

$$Colby ' s equation E = X + Y - XY / 100$$

If the actual/observed anti-phytopathogenic efficacy of the sulphur and laminarin combination against Septoria tritici in wheat exceeds the calculated value, then the activity of the combination is super additive, i.e. a synergistic effect exists. In this case, the efficacy which was actually observed must be greater than the value for the expected efficacy (E) calculated from the abovementioned formula.

Control percentage of Septoria tritici in wheat with the laminarin and sulphur combination, as well as that of sulphur and laminarin separately are provided in table 1 below:

TABLE 3
Control percentage of Septoria tritici

| | | Observed | | Difference between | |
|---|---|---|---|---|---|
| Treatment | | control | Expected | observed & actual | |
| No. | Tested product | (%) | control (%) | efficacy in % | Conclusion |
| 1 | Untreated | — | — | — | — |
| | control | | | | |
| 2 | Sulphur (825 | 71 | — | — | — |
| 3 | Laminarin 37SL | 16 | — | — | — |
| 4. | laminarin 37SL + | 92 | 76 | 14 | Synergistic |
| | Liquid sulphur | | | | |
| | (825 g/L) | | | | |

SL: soluble concentrate
Non-ionic surfactant: polyethylene glycol stearate

Based on the observations from table 3, the present Sulphur and laminarin combination was synergistic and showed exemplary control of the fungi.

### Example 4: Efficacy of Laminarin and Sulphur Formulation

The efficacy of the laminarin and sulphur combination was evaluated by determining the % disease control of Septoria tritici in wheat.
Protocol: A brief description of the treatments used in the protocol is described as below. Treatment 2 includes the composition of Example 1 and treatment 3 includes a tank mix of the composition described in Example 1 and a non-ionic surfactant-polyoxyethylene lauryl ether in a concentration of 15 g/L.

The treatments used in this trial were applied 5 times, the time interval between each application is as follows: application ‘A’ was made at 0 days, ‘B’ is the application at 15 days after application ‘A’, ‘C’ is the application at 6 days after application ‘B’; ‘D’ is the application at 7 days after application ‘C’, ‘E’ is the application at 9 days after application ‘D’. Post inoculation of Septoria tritici species in the wheat crop, observations were made for % efficacy control at 7 DAD, i.e. 7 days after application ‘D’, 28 DAD, i.e. 28 days after application ‘D’, 2 DAE, i.e. 2 days after application E and at 15 DAE, i.e. 15 days after application ‘E’.

TABLE 4
Control percentage of Septoria tritici

| | | | Application amount | | | | | |
|---|---|---|---|---|---|---|---|---|
| | | App. | Actives (g/ha) | | Efficacy (%) | | Efficacy (%) | |
| No. | Treatment | rate | Laminarin | Sulphur | 7 DAD | 28 DAD | 2 DAE | 15 DAE |
| 1. | Untreated | — | — | — | — | — | — | — |
| 2. | Composition - | 3,381 | 37 | 2477 | 0 ab | 34 bc | 50 bc | 43 c |
| | Example 1 | | | | | | | |
| 3. | Composition - | 3,381 | 37 | 2477 | 27 b | 40 c | 61 c | 51 c |
| | Example 1 + | | | | | | | |
| | non-ionic | | | | | | | |
| | surfactant 15 g/L | | | | | | | |
| 4. | laminarin 37SL | 1 L | 37 | — | 0 ab | 0 ab | 39 bc | 10 ab |

SL: soluble concentrate
Non-ionic surfactant: polyoxyethylene lauryl ether

It was observed from the table about that the composition of Example 1 as used in treatment 2 and treatment 3 exhibits efficient control of Septoria triitici compared to treatment 4 relating to solo laminarin. The tank mix of a non-ionic surfactant with the composition in treatment 3 showed the best reduction in fungal growth in wheat.

What is claimed is:

1. A fungicidal combination comprising laminarin and an inorganic compound or its salts for controlling phytopathogenic fungal diseases in cereal crops.

2. The combination as claimed in claim 1, wherein the inorganic compound comprises sulphur or salts thereof.

3. The combination as claimed in claim 1, wherein the inorganic compound comprises copper or salts thereof.

4. The combination as claimed in claim 3, wherein copper comprises copper salts including copper sulphate, tribasic copper sulphate, dibasic copper sulphate.

5. The combination as claimed in claim 1, wherein the laminarin and the inorganic compound are at a weight ratio is ranging from 1:1 to 1:100.

6. The combination as claimed in claim 1, wherein the cereal comprises wheat, maize, rice, barley, oats, rye or sorghum.

7. The combination as claimed in claim 1, wherein the laminarin is in a concentration ranging from 10 to 40 g/L and the inorganic compound is in a concentration ranging from 400 to 1000 g/L.

8. The combination as claimed in claim 1, wherein the combination further comprises a non-ionic surfactant selected from the group comprising comprises fatty acids, ethoxylated fatty acids, polyethers, fatty alcohols, polyethoxylated fatty alcohols and ethoxylated castor oil.

9. The combination as claimed in claim 8, wherein the non-ionic surfactant is in a concentration ranging from 10 to 45 g/L.

10. The combination as claimed in claim 1, wherein the combination comprises an agrochemical comprising a fungicide, a herbicide, an insecticide or a bio-stimulant.

11. A fungicidal composition comprising:
(i) the combination of claim 1; and
(ii) an agriculturally acceptable excipient.

12. The composition as claimed in claim 11, wherein the laminarin is present as a concentrate, wherein the concentrate has a concentration ranging from 1% w/w to 25% w/w and an inorganic compound is in a concentration ranging from 10% w/w to 55% w/w.

13. The composition as claimed in claim 12, wherein the laminarin in the laminarin concentrate is in a concentration ranging from 0.1 g/L to 20 g/L of the composition.

14. The composition as claimed in claim 11, wherein the agriculturally acceptable excipient comprises an anti-freeze agent, a dispersant, a defoamer, a preservatives thickener or a solvent.

15. The composition as claimed in claim 11, wherein the composition is a soluble concentrate, a suspension concentrates (SC), an oil in water emulsion, a water in oil emulsion, an emulsifiable concentrate, a capsule suspensions, ZC formulations, or an oil dispersions.

16. The composition as claimed in claim 11, wherein the composition is applied as a tank mix or sequentially or simultaneously with a non-ionic surfactant selected from the group comprising comprises fatty acids, ethoxylated fatty acids, fatty alcohols, polyether, ethoxylated fatty alcohols and ethoxylated castor oil, wherein the non-ionic surfactant is in a concentration ranging from 10 to 45 g/L.

17. A method of controlling phytopathogenic fungi in cereal crops, the method comprising applying to a locus of the crop the fungicidal combination of claim 1.

18. The method as claimed in claim 17, wherein the laminarin is applied in an amount ranging from 5 to 50 g/ha and the inorganic compound is sulphur applied in an amount ranging from 200 to 1000 g/ha.

19. The method as claimed in claim 17, wherein the fungicidal combination is applied as a tank mix or sequentially or simultaneously with a non-ionic surfactant selected from the group comprising comprises fatty acids, ethoxylated fatty acids, polyethers fatty alcohols, ethoxylated fatty alcohols and ethoxylated castor oil.

20. The method as claimed in claim 17, wherein applying the fungicidal combination is at an ranging from 0.1 to 8 L/ha.

21. The method as claimed in claim 17, wherein the phytopathogenic fungi comprises Zymoseptoria sp, Zymoseptoria tritici, Puccinia sp, Puccinia striiformis, Pryiculari spp., Pyricularia oryzae.
